(19) United States
(12) Patent Application Publication
(10) Pub. No.: US 2024/0400437 A1
(43) Pub. Date: Dec. 5, 2024

(54) FUSION FORMABLE GLASS FOR HIGH UV TRANSMISSION

(71) Applicant: CORNING INCORPORATED, CORNING, NY (US)

(72) Inventors: Nicholas Francis Borrelli, Elmira, NY (US); Lisa Ann Lamberson, Painted Post, NY (US); Joseph Francis Schroeder, III, Lindley, NY (US)

(21) Appl. No.: 18/670,934

(22) Filed: May 22, 2024

Related U.S. Application Data
(60) Provisional application No. 63/471,047, filed on Jun. 5, 2023.

(51) Int. Cl. C03C 3/091; C03C 4/00

(52) U.S. Cl. CPC C03C 3/091; C03C 4/0085

(57) ABSTRACT

Glass materials, glass articles, and sheets of glass materials are disclosed, as well as methods of making these, in which the glass materials comprise alkaline earth metals and have a high deep UV transmission, such as greater than 50% at wavelengths of 245-270 nm, and are further compatible with or formable by large scale manufacturing techniques such as fusion drawing.

### CROSS-REFERENCE TO RELATED APPLICATIONS

This application claims the benefit of priority of U.S. Provisional Patent Application Ser. No. 63/471,047, filed on Jun. 5, 2023, the content of which is relied upon and incorporated herein by reference in its entirety.

### BACKGROUND

Optical properties of glasses dictate their usefulness for many applications, such as photolithographic steps for microchip fabrication in which ultraviolet (UV) light may be transmitted through a glass substrate. Other characteristics of glass influence their manufacturability and cost. For example, while fused silica is highly transparent to UV, fused silica is expensive and it is difficult to form wide sheets of fused silica. Fusion draw processes, for example, enable large-scale manufacturing of wide sheets of glass. Typical glasses formed by fusion drawing, however, have poor UV transmission characteristics. Accordingly, there is a need in the art for improved glass materials.

### SUMMARY

Provided herein are glass materials, glass articles, and sheets of glass materials, as well as methods of making these, having a high deep UV transmission, such as greater than 60% at about 250 nm, and further being compatible with or formable by large scale manufacturing techniques such as fusion drawing.

Aspects disclosed herein include a glass material comprising: a composition comprising, on an oxide basis: silica (SiO₂) selected from the range of 55 mol. % to 75 mol. %, alumina (Al₂O₃) selected from the range of 1 mol. % to 20 mol. %, and boric oxide (B₂O₃) selected from the range of 10 mol. % to 20 mol. %; wherein the composition comprises an RO/Al₂O₃ ratio, on an oxide basis, selected from the range of 0.80 to 3.5, the term RO being the mol. % sum of MgO, CaO, SrO, and BaO; wherein the glass material comprises a total content by weight of amorphous phase being greater than a total content by weight of crystalline phase; and wherein the glass material is characterized by a light transmission of at least 50% at a wavelength selected from the range of about 245 nm to about 270 nm when the glass material is in the form of a sheet having a thickness selected from the range of about 0.3 mm to about 1 mm. Aspects disclosed herein also include a glass article having a glass material disclosed herein. Aspects disclosed herein also include a glass sheet formed of a glass material disclosed herein. Aspects disclosed herein also include a method of making a glass material disclosed herein.

### BRIEF DESCRIPTION OF THE DRAWINGS

FIG. 1: A plot showing transmission of a typical fusion formed glass having a transmission of approximately 37% at 254 nm.

FIG. 2: A plot showing transmission of three alkali alumino-silicate compositions (samples X, Y, and Z). For each of these compositions, the plot shows transmission data before hydrogen reduction (“as made”), after hydrogen reduction (“H2 loaded”), and further after exposure to 248 nm light (“H2+248 nm exp”).

FIG. 3: A plot showing transmission of select glass materials, according to aspects herein, comprising alkaline earth metal oxides. FIG. 3 shows transmission for certain exemplary glass materials whose compositions and various characteristics are summarized in FIGS. 5A-5B.

FIG. 4A: A schematic illustrating electronic bands and states in silicate glasses, showing that pure SiO₂ has a band gap of approximately 7 eV, glasses with alkaline earth metal oxides, such as glass materials disclosed herein, having a band gap of approximately 6 eV, and glasses with alkali metal oxides having a band gap of approximately 5 eV. FIG. 4B: A plot of 1^{st} derivative of signal generated using electron paramagnetic resonance (EPR) on glass materials with alkaline earth metal oxides, the EPR signal showing presence of an Fe⁺³ impurity.

FIGS. 5A-5F: Composition and various characteristics of exemplary glass materials, according to certain aspects herein, referred to as Samples A through F which correspond to Examples 1-6.

FIGS. 6A-6M: Composition and various characteristics of exemplary glass materials, according to certain aspects herein, referred to as Samples G through S which correspond to Examples 7-19.

FIG. 7A-7D: Composition and various characteristics of exemplary glass materials, according to certain aspects herein, referred to as Samples T through W which correspond to Examples 20-23.

FIG. 8: A plot showing absorption of a glass material at 250 nm as a function of number of shots of a UV laser, demonstrating that some materials exhibit an increase in UV absorption with UV exposure.

FIG. 9: A plot showing optical transmission (% T) in a UV region for certain glass material compositions, according to aspects herein, corresponding to select compositions from F to Q (see FIGS. 5 and 6 for composition details), having a thickness of 1 mm.

FIG. 10: A plot showing optical transmission (% T) in the UV region for the same glass materials as in FIG. 9 after exposure thereof to UV laser light.

FIG. 11A-11B: FIG. 11A: A plot showing optical transmission (% T) in a narrow UV region for certain glass material compositions, according to aspects herein, corresponding to select compositions from F to Q (see FIGS. 5 and 6 for composition details), having a thickness of 1 mm. FIG. 11B: A plot showing optical transmission (% T) in the narrow UV region for the same glass materials as in FIG. 11A after exposure thereof to UV laser light.

### STATEMENTS REGARDING CHEMICAL COMPOUNDS AND NOMENCLATURE

In general, the terms and phrases used herein have their art-recognized meaning, which can be found by reference to standard texts, journal references and contexts known to those skilled in the art. The following definitions are provided to clarify their specific use in the context of the disclosure.

Glass materials disclosed herein generally comprise an amorphous phase and have low crystallinity, optionally being free or substantially free of any crystalline phase(s). Preferably, any glass material disclosed herein comprises a total content by weight (total wt. %) of amorphous phase being greater than a total content by weight (total wt. %) of any and all crystalline phase in the glass material. Optionally, for example, a glass material may be characterized as being in a “glass state”, referring to an inorganic amorphous phase material that is a product of melting that has cooled to a rigid condition without crystallizing. Preferably for some applications, glass materials disclosed herein are not glass-ceramic materials, due to the low crystallinity. As used herein, a “glass-ceramic” refers to a glass having both the glass state and a crystalline phase and/or crystalline precipitates. Optionally in any aspect disclosed herein, glass materials disclosed herein are amorphous glass materials, having low crystallinity, optionally being substantially free of crystallinity or of crystalline phases. Optionally in any aspect disclosed herein, a glass material disclosed herein is characterized by a total crystallinity equal to or less than about 10% by weight (wt. %), optionally equal to or less than about 8 wt. %, optionally equal to or less than about 5 wt. %, optionally equal to or less than about 4 wt. %, optionally equal to or less than about 3 wt. %, optionally equal to or less than about 2 wt. %, optionally equal to or less than about 1 wt. %, optionally equal to or less than about 0.8 wt. %, optionally equal to or less than about 0.5 wt. %, optionally equal to or less than about 0.2 wt. %, optionally equal to or less than about 0.1 wt. %, optionally equal to or less than about 0.08 wt. %, optionally equal to or less than about 0.05 wt. %, optionally equal to or less than about 0.01 wt. %. As used herein, total crystallinity refers to the sum of the wt. % of all crystal phases present in the glass material. The total crystallinity of the glass material can be determined through Rietveld quantitative analysis of X-ray diffraction (XRD) data measured from the glass material or a representative sample thereof. For example, the XRD may be measured using a sheet of the glass material, or alternatively a powder of the glass material, for example. Optionally, XRD data is collected using a powder x-ray diffraction technique with a scan from 5 to 80 degrees, unless otherwise specified. For example, the Rietveld quantitative analysis method employs a least squares method to model the XRD data and then determines the concentration of phases in the sample based on known lattice and scale factors for the identified phases. However, it is understood that different methods and instrumentation for determining total crystallinity can also be employed.

Unless otherwise specified, the term “ppm” refers to parts per million by weight.

As used herein, the term alkali metal or alkali metal element refers to a metal element corresponding to the Group 1 metals of the Periodic Table of Elements, consisting of Li, Na, K, Rb, Cs, and Fr. An alkali metal compound is a compound (e.g., a metal oxide, a metal fluoride, etc.) of an alkali metal. An alkali metal oxide or an alkali metal oxide compound is an oxide compound of an alkali metal, such as Li₂O, Na₂O, K₂O, Rb₂O, Cs₂O, and Fr₂O. As used herein, an “alkali-free glass” is a glass having a total alkali metal oxide concentration which is less than or equal to 0.1 mole percent, where the total alkali concentration is the sum of the Li₂O, Na₂O, K₂O, Rb₂O, Cs₂O, and Fr₂O concentrations. Typically, total alkali metal compound concentration in a glass material can be estimated as the sum of the Li₂O, Na₂O, K₂O, Rb₂O, and Cs₂O concentrations. In some aspects, the total alkali metal compound, or total alkali metal oxide, concentration in a glass material is less than or equal to 0.1 mole percent. As used herein, R₂O refers to the total concentration, typically as mol. %, of alkali metal oxides such as Li₂O, Na₂O, K₂O, Rb₂O, and Cs₂O in a glass material. Unless otherwise specified, R₂O is the sum of Li₂O, Na₂O, K₂O, Rb₂O, and Cs₂O in a glass material, though if desired R₂O can be limited to any one of Li₂O, Na₂O, K₂O, Rb₂O, or Cs₂O, or any combination thereof, as will be clear from context.

As used herein, the term alkaline metal and alkaline earth metal are used interchangeably to refer to any metal element in Group 2 of the Periodic Table of Elements, consisting of beryllium (Be), magnesium (Mg), calcium (Ca), strontium (Sr), barium (Ba), and radium (Ra). An alkaline metal compound is a compound (e.g., a metal oxide, a metal fluoride, etc.) of an alkaline earth metal. An alkaline metal oxide, an alkaline earth metal oxide, or an alkaline metal oxide compound is an oxide compound of an alkaline earth metal, such as but not limited to MgO, CaO, SrO, and BaO. As used herein, the term RO refers to the total concentration, typically as mol. %, of alkaline earth metal oxides such as MgO, CaO, SrO, and BaO in a glass material. As used herein, RO does not include other metal oxide compounds of divalent metal cations that are not alkaline earth metals; for example, RO does not include metal oxide compounds of transition metals such as Fe and Zn.

Optionally, a glass material disclosed herein has a composition comprising an RO selected from the range of 7 mol. % (optionally 7.5 mol %, optionally 8.0 mol %, optionally 8.1 mol %, optionally 8.2 mol %, optionally 8.3 mol %, optionally 8.5 mol %, optionally 8.6 mol %, optionally 8.7 mol %, optionally 8.9 mol %, optionally 9.0 mol %, optionally 9.1 mol %, optionally 9.2 mol %, optionally 9.3 mol %, optionally 9.5 mol %, optionally 9.7 mol %, optionally 9.9 mol %, optionally 10.0 mol %, optionally 10.1 mol %) to 15 mol. % (optionally 14.5 mol %, optionally 14.0 mol %, optionally 13.5 mol %, optionally 13.0 mol %, optionally 12.5 mol %, optionally 12.0 mol %, optionally 11.7 mol %, optionally 11.5 mol %, optionally 11.2 mol %, optionally 11.0 mol %, optionally 10.5 mol %).

As used herein, the terms “light transmission” and “transmission” are used interchangeably to refer to a percent transmission (% T) of light intensity, characterized by a referenced wavelength or range of wavelengths, transmitted through a material, such as a glass material formed in the shape of a sheet or film having a referenced thickness. Unless otherwise specified, transmission or % T refers to external transmission, as the term is recognized in the fields of optics and physics.

The terms Young's modulus and elastic modulus are used interchangeably herein and may be provided in units of gigaPascals (GPa). The elastic modulus of a glass material can determined by resonant ultrasound spectroscopy on bulk samples of the glass material, such as using a sheet of the glass material. For example, the elastic modulus of glass materials disclosed herein can be determined by a resonant ultrasonic spectroscopy technique of the general type set forth in ASTM E2001-13, titled “Standard Guide for Resonant Ultrasound Spectroscopy for Defect Detection in Both Metallic and Non-metallic Parts,” and are reported in GPa, unless otherwise specified.

As used herein, the term “liquidus viscosity” refers to the viscosity of a molten glass at its liquidus temperature, wherein the term “liquidus temperature” refers to the temperature above which a material is completely liquid, optionally the maximum temperature at which crystals can co-exist with the melt in thermodynamic equilibrium or the temperature at which crystals first appear as a molten glass cools down from the melting temperature or the temperature at the onset of devitrification. Above the liquidus temperature the material is homogeneous and liquid at equilibrium. For example, a liquidus temperature can be determined with the gradient furnace method according to ASTM C829-81. For example, first the liquidus temperature of the glass can be measured in accordance with ASTM C829-81 (2015), titled “Standard Practice for Measurement of Liquidus Temperature of Glass by the Gradient Furnace Method”. Next the viscosity of the glass at the liquidus temperature can be measured in accordance with ASTM C965-96 (2012), titled “Standard Practice for Measuring Viscosity of Glass Above the Softening Point”.

The term “coefficient of thermal expansion” or “CTE” refers to the coefficient of thermal expansion of a glass material, optionally over a temperature range from about 20° C. to about 350° C., unless otherwise specified. Optionally, a glass material disclosed herein has a CTE that is matched to or within 20%, or within any percentage less than 20%, of the CTE of a silicon substrate. In some aspects, a silicon substrate has a CTE of about 30 ppm/° C., and a CTE of a glass material is within 20% of this silicon substrate CTE. Optionally, a glass material disclosed herein has a CTE that is selected from the range of 0.2 to 0.8 ppm/° C., optionally any range or values therebetween, such as 0.4 to 0.6 ppm/° C.

As used herein, the term “softening point” refers to the temperature at which the viscosity of a glass is approximately 107.6 poise (P). The softening point can be determined using the parallel plate viscosity method of ASTM C1351M-96 (2012). The term “anneal point” refers to the temperature at which the viscosity of a glass is approximately 10^{13.2} poise.

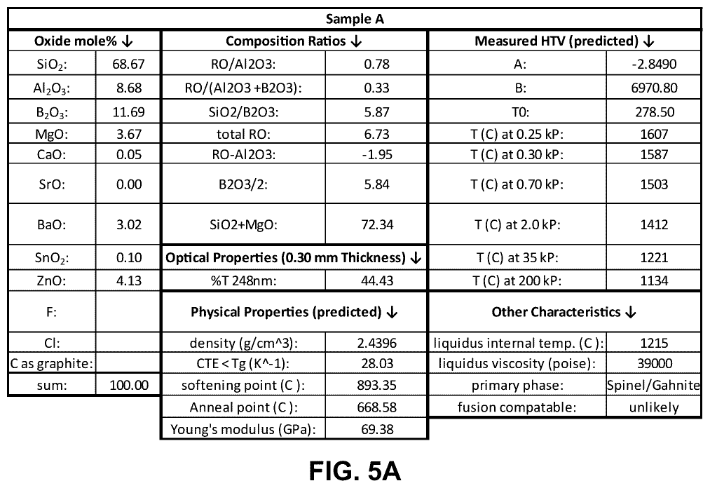

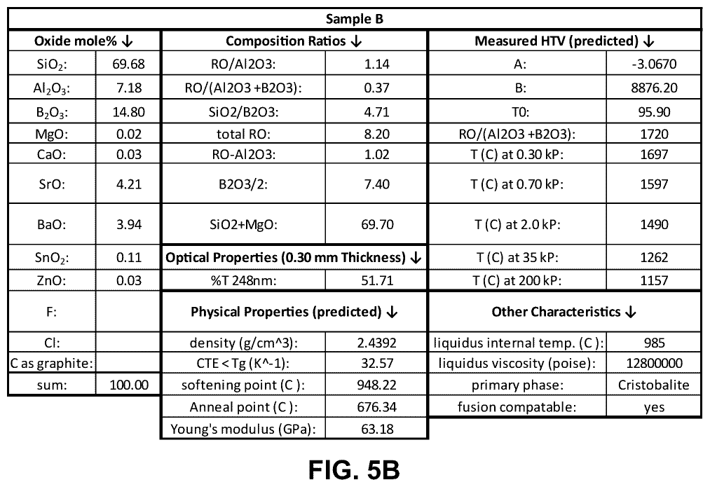

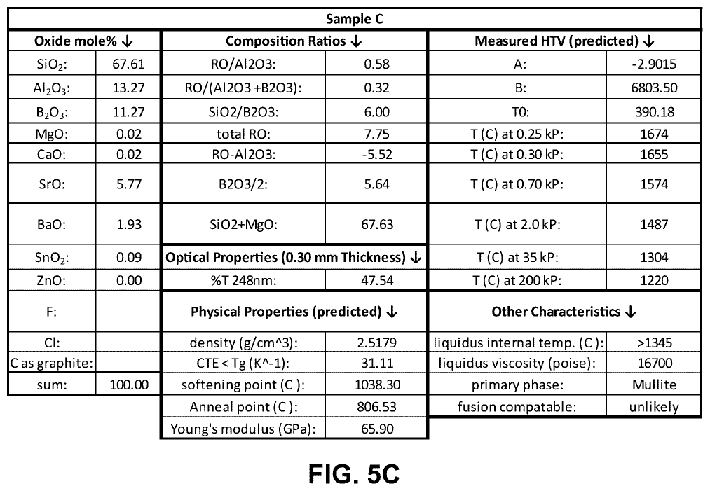

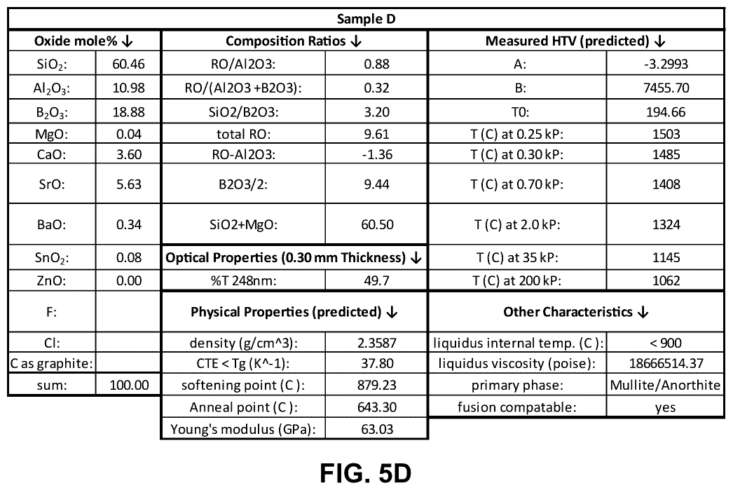

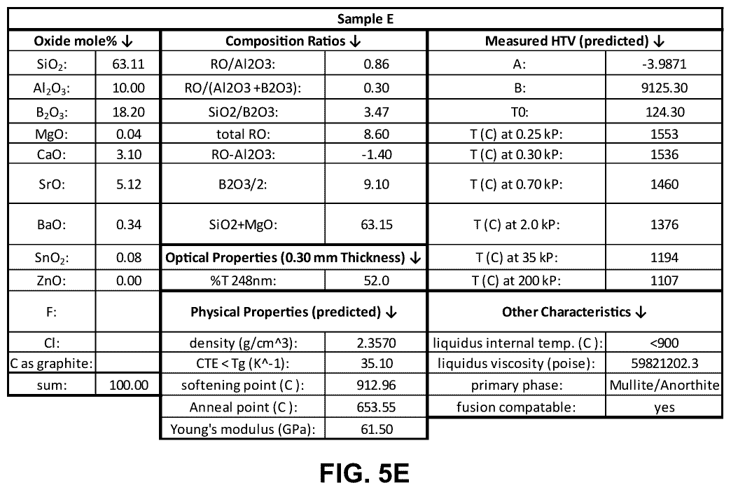

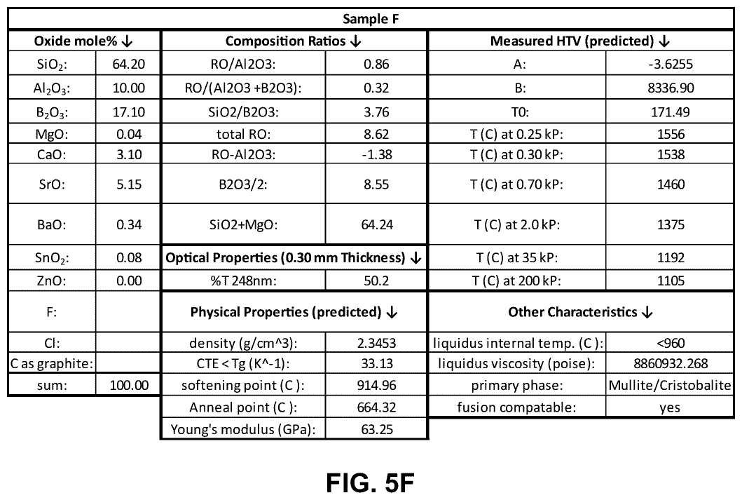

The term “HTV” refers to “high temperature viscosity”. The tables in FIGS. 5A-5F include HTV characteristics, where the parameters A, B, and T₀ are fitting constants, which are generally material-dependent, corresponding to the Vogel-Fulcher-Tammann (VFT) equation. The equation for determining temperature at a reference liquidus viscosity is [T_{liq}=T₀+B/(log (μ_{liq})−A)], where “μ_{liq}” is liquidus viscosity in units of poise, T_{liq} is the liquidus temperature (° C.), and A, B, and T₀ are the fitting constants identified in FIGS. 5A-5F. In the tables of FIGS. 5A-5F, the A, B, and T₀ parameters are followed by temperatures at different viscosities (0.25 kP, 0.30 kP, 0.70 kP, 2.0 kP, 35 kP, and 200 kP) as determined by Fulcher fit to high temperature viscosity (HTV) data. Similarly, these constants may be used to determine liquidus viscosity at a reference liquidus temperature using the equation [μ_{liq}=A+B/(T_{liq}−T₀)].

Unless otherwise specified, density values recited herein refer to a value as measured by the buoyancy method of ASTM C693-93 (2013).

As used herein, the terms “glass article” and “a glass” may be used interchangeably, and in their broadest sense, include any object made wholly or partly of glass, such as a glass material disclosed herein. “Glass-based articles” include laminates of glass and non-glass materials, and laminates of glass and crystalline materials. A glass-based article may be, for example, but is not limited to a glass substrate having other glass and/or non-glass materials disposed thereon, such as a glass substrate having metal, polymer, and/or semiconductor material(s) deposited thereon. A glass-based article may be, for example, but is not limited to a laminate of glass and non-glass material(s), a laminate of glass and crystalline material(s), a laminate of glass and glass-ceramic(s), or any combination thereof. A device may be an electronic or electrochemical device, for example, such as, but not limited to, a battery cell, a photovoltaic cell, a photochromic cell or window, etc. having glass(es) and/or glass-based article(s), such as in the form of a glass substrate being or comprising a glass material according to aspects disclosed herein.

The term “substantially” refers to a property, condition, or value that is within 20%, 10%, within 5%, within 1%, optionally within 0.1%, or is equal to a reference property, condition, or value. The term “substantially equal”, “substantially equivalent”, or “substantially unchanged”, when used in conjunction with a reference value describing a property or condition, refers to a value that is within 20%, within 10%, optionally within 5%, optionally within 1%, optionally within 0.1%, or optionally is equivalent to the provided reference value. For example, a temperature is substantially equal to 100° C. (or, “is substantially 100° C.”) if the temperature is within 20%, optionally within 10%, optionally within 5%, optionally within 1%, within 0.1%, or optionally equal to 100° C. The term “substantially greater”, when used in conjunction with a reference value describing a property or condition, refers to a value that is at least 1%, optionally at least 5%, optionally at least 10%, or optionally at least 20% greater than the provided reference value. The term “substantially less”, when used in conjunction with a reference value describing a property or condition, refers to a value that is at least 1%, optionally at least 5%, optionally at least 10%, or optionally at least 20% less than the provided reference value.

As used herein, the term “about” means a range of values including the specified value, which a person of ordinary skill in the art would consider reasonably similar to the specified value, reflecting for example tolerances, conversion factors, rounding off, measurement error and the like, and other factors known to those of skill in the art. In some aspects, about means within a standard deviation using measurements generally acceptable in the art. In some aspects, about means a range extending to +/−10% of the specified value. In some aspects, about means the specified value. In some aspects, the terms “about” and “substantially” are interchangeable and have identical means. For example, a temperature of about 100° C. refers to a temperature within 20%, optionally within 10%, optionally within 5%, optionally within 1%, optionally within 0.1%, or optionally equal to 100° C.

As used herein, the language “substantially free,” when used to describe a constituent of a material, composition, batch, melt, or article, refers to a constituent that is present in a small amount of less than about 0.1% (by mole of oxide), optionally less than about 0.05 mol. %, optionally less than about 0.01 mol. %, optionally less than about 0.001 mol. %, typically as a contaminant and/or due to the inherent degree of uncertainty attributed to any measurement or analysis technique. Generally, but not necessarily, when the term “substantially free” is used to describe a constituent of a composition, batch, melt, or article, such a constituent typically is not actively or intentionally added or batched into the composition, batch, melt, or article. The terms “0 mol %,” “free,” and the like when used to describe the concentration and/or absence of a particular constituent component in a material, composition, batch, melt, or article, means that the constituent component is not detectable by standard analytical techniques typically used to measure for the particular constituent component at issue, and generally such particular component is not intentionally added to the glass-based article.

The term “and/or” is used herein, in the description and in the claims, to refer to a single element alone or any combination of elements from the list in which the term and/or appears.

The term “±” refers to an inclusive range of values, such that “X±Y,” wherein each of X and Y is independently a number, refers to an inclusive range of values selected from the range of X−Y to X+Y. In the cases of “X±Y” wherein Y is a percentage (e.g., 1.0±20%), the inclusive range of values is selected from the range of X−Z to X+Z, wherein Z is equal to X·(Y/100). For example, 1.0±20% refers to the inclusive range of values selected from the range of 0.8 to 1.2.

Additional background information, terms and definitions, descriptions of techniques or processes such as measurement techniques for various properties and characteristics provided herein, descriptions of techniques or processes such as down draw processes such as fusion drawing for forming glass materials and sheets thereof, descriptions of some functions or roles of some compounds or elements in a glass material, descriptions of some crystalline phases, and some aspects may be found in the following US patent documents, each of which is incorporated herein by reference to the extent not inconsistent herewith: U.S. Pat. Nos. 11,542,193, 11,577,987, 11,584,681, US Pat. Pub. 2020/0339468, U.S. Pat. No. 10,787,387, 9,878,940, US Pat. Pub. 2019/0047898, U.S. Pat. Nos. 9,919,951, 11,554,982, 11,591,249, US Pat. Pub. 2023/0015444, US Pat. Pub. 2023/0017932, US Pat. Pub. 2023/0027062, US Pat. Pub. 2023/0056119, US Pat. Pub. 2023/0057346, U.S. Pat. No. 9,540,278, and US Pat. Pub. 2016/036881.

In some aspects, a material, composition, or compound of the disclosure, such as a glass material or precursor to a glass material, is isolated or substantially purified. In some aspects, an isolated or purified material, composition, or compound is at least partially isolated or substantially purified as would be understood in the art. In some aspects, a substantially purified material, composition, or compound of the disclosure has a chemical purity of 95%, optionally for some applications 99%, optionally for some applications 99.9%, optionally for some applications 99.99%, and optionally for some applications 99.999% pure.

### DETAILED DESCRIPTION

In the following description, numerous specific details of the devices, device components and methods of the present disclosure are set forth in order to provide a thorough explanation of the precise nature of the disclosure. It will be apparent, however, to those of skill in the art that the disclosure can be practiced without these specific details.

Without wishing to be bound by any particular theory, there may be discussion herein of beliefs or understandings of underlying principles relating to the materials, compositions, and methods disclosed herein. It is recognized that regardless of the ultimate correctness of any mechanistic explanation or hypothesis, an aspect of the disclosure can nonetheless be operative and useful.

In many microchip fabrication processes there are photolithographic steps which involve using UV light, such as in a photoresist step which needs deep UV (˜250 nm) optical transmission for the exposure. Other applications and methods may also be facilitated by high UV transmission. Any materials, such as glass substrates, between the exposure beam and the silicon substrate should be highly transparent in the UV region of the spectrum. Most commonly available glasses are not sufficiently transparent at these UV wavelengths, such as 245-270 nm. The UV transparency of the glass dictates the exposure time, with lower transparency translating to longer exposure times being required. Shorter exposure time allows for faster the throughput, however, which is desired for production costs.

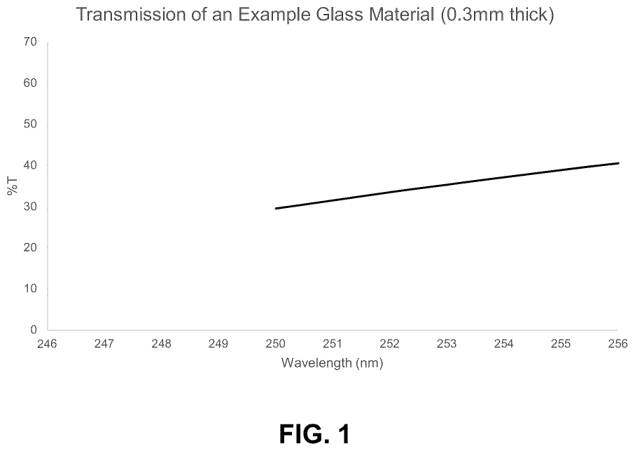

Generally, deep-UV transparent glass is fused silica. However, the manufacturing cost of fused silica is prohibitively high. It has been observed that any component addition to silica to make a less expensive glass also reduces the UV transmission. The commonly added components such as alkali metal ions significantly decrease UV transmission of the glass. Therefore, there is an important need for glass materials that have high deep UV (e.g., ˜250 nm) transmission while also being compatible with large scale manufacturing techniques such as down draw processes, including fusion drawing. Unfortunately, typical wide sheet produced glasses made by the fusion process have poor deep UV transmission (e.g., FIG. 1). The composition of the glass whose transmission is shown in FIG. 1 has 67.57 mol. % SiO₂, 11.03 mol. % Al₂O₃, 9.69 mol. % B₂O₃, 2.29 mol. % MgO, 8.76 mol. % CaO, 0.5 mol. % SrO, 0.01 mol. % BaO, and 0.08 mol. % SnO₂. In the particular case of this material represented by FIG. 1, the cause of low UV transmission may include the use of SnO₂ as a fining agent and use of non-high purity raw materials which typically have a concentration of Fe³⁺ sufficient to diminish UV transmission.

In some aspects, glass materials disclosed herein have high transmission (% T) at wavelengths of deep UV. The preferred particular minimum transmission and wavelength generally depends on a particular application, on other layers or coatings deposited on the glass material, and/or on the properties of the material(s) being exposed to UV through the glass material. For some applications, for example, it is desirable for the glass material to have a transmission of at least 60% at a wavelength corresponding to the primary peak wavelength of a deep UV light source, such as at ˜248 nm (KrF), at ˜254 nm (Hg), and/or at ˜266 nm (4th Harmonic YAG). For example, in some aspects, the glass material is characterized by a light transmission of at least 50% (optionally at least 55%, optionally at least 60%, optionally at least 65%, optionally at least 70%, optionally selected from the range of 50% to 80%, optionally selected from the range of 55% to 80%, optionally selected from the range of 60% to 80%, optionally selected from the range of 65% to 80%, optionally selected from the range of 70% to 80%) at any single wavelength or any combination of wavelengths selected from the range of about 245 nm to about 270 nm (optionally at any single wavelength or any combination of wavelengths selected from the range of about 248 nm to about 266 nm, optionally at any single wavelength or any combination of wavelengths selected from the range of about 245 nm to about 255 nm, optionally at 248 nm, optionally at all wavelengths selected from the range of about 245 nm to about 270 nm, optionally at all wavelengths selected from the range of about 248 nm to about 266 nm, optionally at all wavelengths selected from the range of about 245 nm to about 255 nm) when the glass material is in the form of a sheet having a thickness selected from the range of about 0.3 mm to about 1 mm (optionally a thickness of about 0.3 mm, optionally a thickness of about 0.5 mm, optionally a thickness of about 0.7 mm, optionally a thickness of about 1.0 mm). In some aspects, for example, the glass material is characterized by an average light transmission of at least 50% (optionally at least 55%, optionally at least 60%, optionally at least 65%, optionally at least 70%, optionally selected from the range of 50% to 80%, optionally selected from the range of 55% to 80%, optionally selected from the range of 60% to 80%, optionally selected from the range of 65% to 80%, optionally selected from the range of 70% to 80%) throughout a wavelength range being about 245 nm to about 270 nm (optionally about 248 nm to about 266 nm, optionally about 245 nm to about 255 nm) when the glass material is in the form of a sheet having a thickness selected from the range of about 0.3 mm to about 1 mm (optionally a thickness of about 0.3 mm, optionally a thickness of about 0.5 mm, optionally a thickness of about 0.7 mm, optionally a thickness of about 1.0 mm). In some aspects, for example, the glass material is characterized by a light transmission of at least 50% (optionally at least 55%, optionally at least 60%, optionally at least 65%, optionally at least 70%, optionally selected from the range of 50% to 80%, optionally selected from the range of 55% to 80%, optionally selected from the range of 60% to 80%, optionally selected from the range of 65% to 80%, optionally selected from the range of 70% to 80%) throughout a wavelength range being about 245 nm to about 270 nm (optionally about 248 nm to about 266 nm, optionally about 245 nm to about 255 nm) when the glass material is in the form of a sheet having a thickness selected from the range of about 0.3 mm to about 1 mm (optionally a thickness of about 0.3 mm, optionally a thickness of about 0.5 mm, optionally a thickness of about 0.7 mm, optionally a thickness of about 1.0 mm). In some aspects, for example, the glass material is characterized by a light transmission of at least 50% (optionally at least 55%, optionally at least 60%, optionally at least 65%, optionally at least 70%, optionally selected from the range of 50% to 80%, optionally selected from the range of 55% to 80%, optionally selected from the range of 60% to 80%, optionally selected from the range of 65% to 80%, optionally selected from the range of 70% to 80%) at a majority (i.e., over 50%) of wavelengths in a wavelength range being about 245 nm to about 270 nm (optionally about 248 nm to about 266 nm, optionally about 245 nm to about 255 nm) when the glass material is in the form of a sheet having a thickness selected from the range of about 0.3 mm to about 1 mm (optionally a thickness of about 0.3 mm, optionally a thickness of about 0.5 mm, optionally a thickness of about 0.7 mm, optionally a thickness of about 1.0 mm). In some aspects, for example, the glass material is characterized by a light transmission of at least 50% (optionally at least 55%, optionally at least 60%, optionally at least 65%, optionally at least 70%, optionally selected from the range of 50% to 80%, optionally selected from the range of 55% to 80%, optionally selected from the range of 60% to 80%, optionally selected from the range of 65% to 80%, optionally selected from the range of 70% to 80%) of light having a wavelength of 248 nm, 254 nm, and/or 266 nm when the glass material is in the form of a sheet having a 1 mm thickness (optionally a 0.7 mm thickness, optionally a 0.5 mm thickness, optionally a 0.3 mm thickness). In some aspects, for example, the glass material is characterized by a light transmission of at least at least 60% of light having a wavelength of 248 nm, 254 nm, and/or 266 nm when the glass material is in the form of a sheet having a 1 mm thickness. In some aspects, for example, the glass material is characterized by a light transmission of at least at least 60% of light having a wavelength of 248 nm, 254 nm, and/or 266 nm when the glass material is in the form of a sheet having a 0.3 mm thickness. In some aspects, for example, the glass material is characterized by a light transmission of at least at least 70% of light having a wavelength of 248 nm, 254 nm, and/or 266 nm when the glass material is in the form of a sheet having a 0.3 mm thickness. Each of the foregoing numbers can be preceded by the word “about,” “at least about,” or “less than about,” and any of the foregoing numbers can be used singly to describe an open-ended range or in combination to describe a close-ended range.

At the same time, other features of glass materials also influence usefulness in certain applications, such as manufacturing processes including microchip fabrication processes. For example, it is advantageous for a glass substrate to have a coefficient of thermal expansion that closely matches that of silicon. In addition, from a cost perspective the ability to make glass sheets in a wide format is desirable.

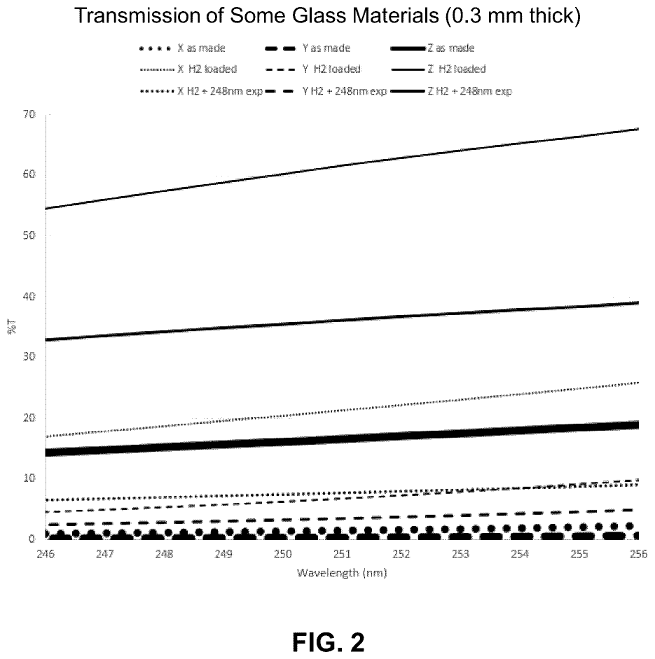

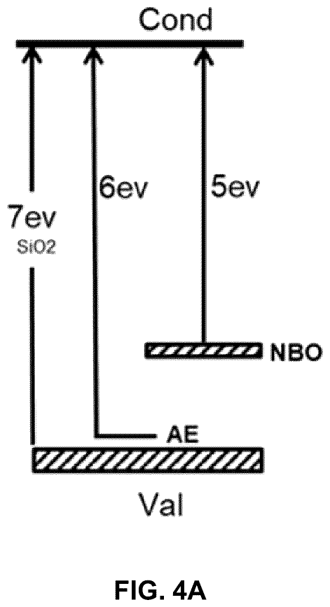

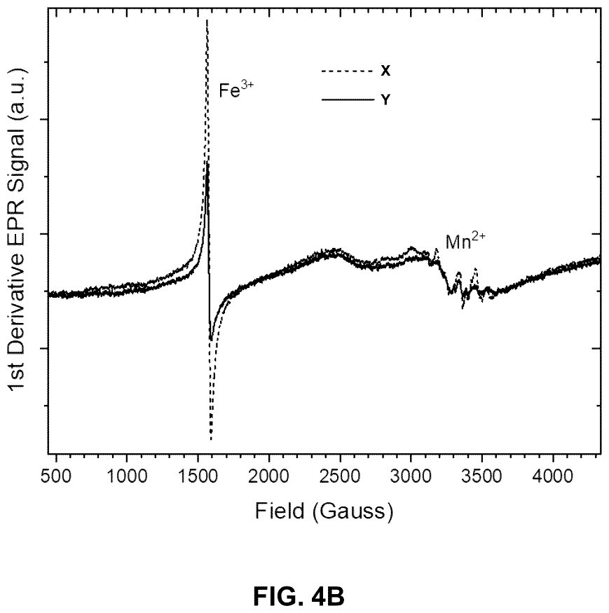

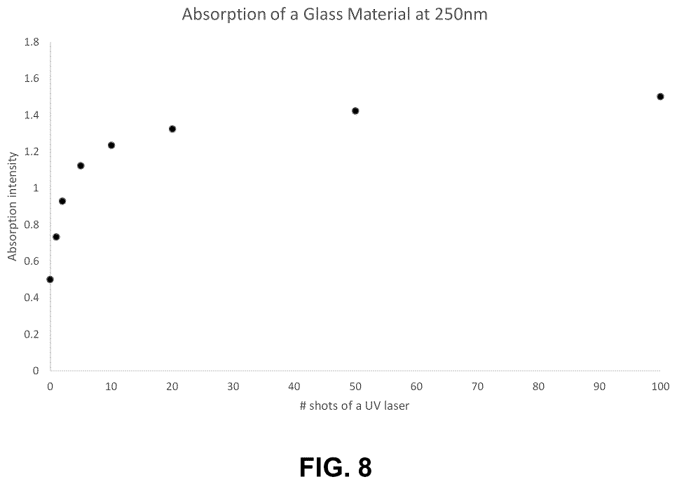

Glass manufacture techniques that include melting place constraints on the physical and optical properties. For the UV transmission, most commercial glasses contain alkali metal ions such as Li, Na, and K. The presence of these ions produces defects called non-bridging oxygens (NBOs) or oxygen dangling bonds, which decrease UV transmission of the glass therewith. This structure has the consequence that it creates energy states in the nominal silica bonding structure, such as illustrated in FIG. 4A. The introduction of energy states within the SiO₂ optical gap reduces the UV transmission of the resulting glass. One approach that has been explored to increase the deep UV transmission in alkali metal-containing glasses is matching the molar alkali content to molar content of alumina or boron in the glass, to help keep an amount non-bridging oxygen atoms low, followed by treating the glass in H₂ at a high temperature (see FIG. 2) and use expensive Fe-free batch materials. FIG. 2 shows that H₂ reduction with exemplary alkali metal-containing glasses compositions X, Y, and Z has the effect of increasing optical transmission. Although H₂ reduction may increase transmission, such glass compositions are generally not fusion formable and are costly to make. Additionally, such compositions may exhibit a solarization effect when exposed to UV light, such as at 248 nm, which reduces optical transmission, as also shown in FIG. 2. The 248 nm exposure with samples X, Y, and Z is performed similarly to the UV exposure described below with respect to FIGS. 8, 10, and 11B.

In some aspects, glass materials disclosed herein are substantially free of alkali metal ions, such as Li, Na, and K, the presence of which would otherwise decrease the optical transmission of the glass material in UV wavelengths. In some aspects, for example, the composition of the glass material is free or substantially free of alkali metals. In some aspects, for example, the composition of the glass material comprises a sum of Li₂O, Na₂O, K₂O, Rb₂O and Cs₂O being less than or equal to 0.5 mol. % (optionally less than or equal to 0.3 mol. %, less than or equal to 0.1 mol. %, optionally less than or equal to 0.05 mol. %, optionally less than or equal to 0.01 mol. %, optionally less than or equal to 0.001 mol. %). In some aspects, for example, the composition of the glass material comprises a sum of Li₂O, Na₂O, K₂O, Rb₂O and Cs₂O being less than or equal to 0.2 wt. % (optionally less than or equal to 0.1 wt. %, less than or equal to 0.05 wt. %, optionally less than or equal to 0.01 wt. %, optionally less than or equal to 0.005 wt. %, optionally less than or equal to 0.001 wt. %). Each of the foregoing numbers can be preceded by the word “about,” “at least about,” or “less than about,” and any of the foregoing numbers can be used singly to describe an open-ended range or in combination to describe a close-ended range.

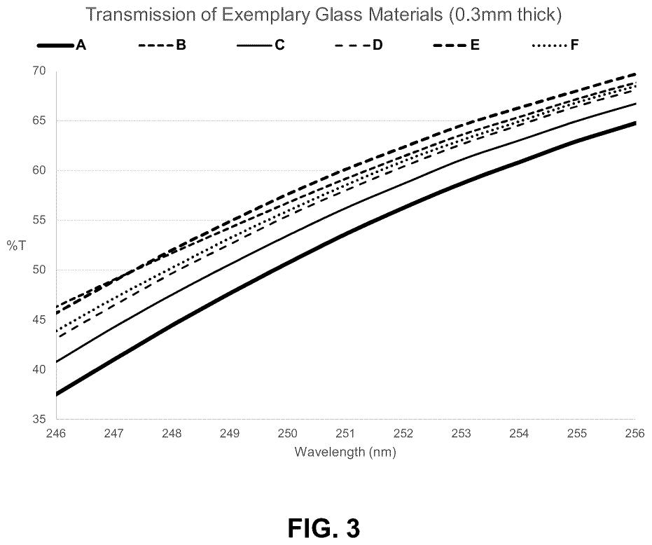

On the other hand, there are glasses that are alkali free and contain what are termed alkaline earth metal elements. The alkaline earth metals or compounds thereof bond into the silica network altering electronic states in energy gap between the conduction and valence bands of SiO₂ that are otherwise responsible for poor UV transmission (e.g., eliminating such undesired states, moving such undesired states closer to the SiO₂ valence band, and/or moving such undesired states into the SiO₂ valence band). FIG. 3, for example, shows transmission of exemplary glass materials according to some aspects herein.

In some aspects, glass materials disclosed herein comprise alkaline earth metals according to some compositional ratios, some of which are found to correlate to high UV transmission, and/or according to some compositional ranges of alkaline earth metal compounds. For example, in some aspects, the glass material is characterized by a composition comprising an RO/Al₂O₃ ratio, on an oxide basis, selected from the range of 0.80 (optionally 0.83, optionally 0.84, optionally 0.85, optionally 0.86, optionally 0.87, optionally 0.9, optionally 0.92, optionally 0.95, optionally 0.98, optionally 1.0) to 3.5 (optionally 1.25, optionally 1.3, optionally 1.35, optionally 1.4, optionally 1.45, optionally 1.5, optionally 1.7, optionally 1.9, optionally 2.0, optionally 2.5, optionally 3.0), the term RO being the mol. % sum of MgO, CaO, SrO, and BaO. For example, in some aspects, the glass material is characterized by a composition comprising an RO/Al₂O₃ ratio, on an oxide basis, selected from the range of 0.80 to 1.35. For example, in some aspects, the glass material is characterized by a composition comprising an RO/(Al₂O₃+B₂O₃) ratio, on an oxide basis, selected from the range of 0.2 (optionally 0.25, optionally 0.28, optionally 0.3, optionally 0.32, optionally 0.35, optionally 0.4) to 0.65 (optionally 0.62, optionally 0.6, optionally 0.58, optionally 0.55, optionally 0.52, optionally 0.5, optionally 0.48, optionally 0.45). For example, in some aspects, the glass material is characterized by a composition comprising a mol. % ratio of SiO₂/B₂O₃ selected from the range of 3.2 (optionally 3.5, optionally 3.7, optionally 4.0) to 6.0 (optionally 5.8, optionally 5.5, optionally 5.2, optionally 5.0). For example, in some aspects, the glass material is characterized by a composition comprising RO selected from the range of 7.0 mol. % (optionally 7.5, optionally 8.0, optionally 8.2, optionally 8.4, optionally 8.5, optionally 8.6, optionally 8.8, optionally 9.0 mol. %) to 11.5 mol. % (optionally 11.0, optionally 10.5, optionally 10.0, optionally 9.5 mol. %). For example, in some aspects, the glass material is characterized by a composition comprising comprises |RO−Al₂O₃| being selected from the range of 1.0 mol. % (optionally 1.3 mol. %) to 8.0 mol. % (optionally 7.7, optionally 7.5, optionally 7.0, optionally 6.5, optionally 6.0, optionally 5.5, optionally 5.0, optionally 4.5, optionally 4.0, optionally 3.5, optionally 3.0, optionally 2.5, optionally 2.0 mol. %). For example, in some aspects, the glass material is characterized by a composition comprising comprises (B₂O₃)/2 being selected from the range of 6.0 mol. % (optionally 6.2, optionally 6.5, optionally 6.7, optionally 6.8 mol. %) to 11 mol. % (optionally 10.5, optionally 10.0, optionally 9.5, optionally 9.0, optionally 8.5, optionally 8.0 mol. %). For example, in some aspects, the glass material is characterized by a composition comprising a sum of SiO₂ and MgO being selected from the range of 55 mol. % (optionally 60 mol. %, optionally 62 mol. %, optionally 65 mol. %) to 80 mol. % (optionally 78 mol. %, optionally 75 mol. %). For example, in some aspects, the glass material is characterized by a composition comprising a higher sum concentration of [Sr and Ba] and/or of [Sr and Ca] than of [Mg and Ca]. Each of the foregoing numbers can be preceded by the word “about,” “at least about,” or “less than about,” and any of the foregoing numbers can be used singly to describe an open-ended range or in combination to describe a close-ended range.

Glass materials with alkaline earth metal compounds, such as those disclosed herein, have different physical properties than the more common alkali-containing glasses, while also being fusion formable. For example, optionally, some glass materials disclosed herein have characteristics favorable for fusion forming, such as liquidus viscosity being greater than 140 kP, a liquidus internal temperature of greater than 1200° C. when viscosity is 35 kP, and a zircon breakdown viscosity of less than ˜35 kP. Some glass materials disclosed herein also have a coefficient of thermal expansion that is well matched to silicon so that the glass materials may be used as substrates for silicon devices during fabrication, for example.

In some aspects, glass materials disclosed herein have a high liquidus viscosity, which facilitates use of fusion draw processes to manufacture the glass materials. In some aspects, for example, the glass material is characterized by a liquidus viscosity greater than or equal to 100 kilopoise (kP) (optionally greater than or equal to 110 kP, optionally greater than or equal to 120 kP, optionally greater than or equal to 125 kP, optionally greater than or equal to 130 kP, optionally greater than or equal to 140 kP, greater than or equal to 145 kP, greater than or equal to 150 kP). In some aspects, for example, the glass material is characterized by a liquidus viscosity greater than or equal to 100 kilopoise (kP) (optionally greater than or equal to 110 kP, optionally greater than or equal to 120 kP, optionally greater than or equal to 125 kP, optionally greater than or equal to 130 kP, optionally greater than or equal to 140 kP, optionally greater than or equal to 145 kP, optionally greater than or equal to 150 kP, optionally greater than or equal to 160 kP, optionally greater than or equal to 170 kP, optionally greater than or equal to 180 kP, optionally greater than or equal to 190 kP, optionally greater than or equal to 200 kP) and less than or equal to 500000 kP (optionally less than or equal to 200000 kP, optionally less than or equal to 100000 kP, optionally less than or equal to 50000 kP, optionally less than or equal to 20000 kP, optionally less than or equal to 10000 kP, optionally less than or equal to 5000 kP, optionally less than or equal to 2000 kP, optionally less than or equal to 1000 kP). Each of the foregoing numbers can be preceded by the word “about,” “at least about,” or “less than about,” and any of the foregoing numbers can be used singly to describe an open-ended range or in combination to describe a close-ended range.

Deep UV transmission of glass compositions depends on the electronic band structure of the silica-based glass network, which is modified by the composition constituents and their amounts. For example, Fe⁺³ as well as other transition metals, which may come from the impurity of the batch materials used in melting of the glass, or which may be intentionally added for certain applications, introduce energy states in the electronic band structure which in turn reduce the UV transmission of the material. Without wishing to be bound by any particular theory, an advantage of alkaline earth metal containing glass materials is higher tolerance for impurities such as Fe(III), which is largely reduced to Fe(II) in these glass materials having alkaline earth metals. As a result, there is not a need to have ultrapure expensive batch materials, though ultrapure batch materials may be utilized if desired.

An illustration of the electronic band gap is shown in FIG. 4A. It compares fused silica (largest bandgap and most UV transparent glass) to that of a typical alkali silicate glass base and that of the alkaline earth silicate glasses, such as glass materials disclosed herein. The valence band states of silicate glasses correspond to p-orbitals of oxygen ions. The conduction band states correspond to sp3 orbitals of the Si—O bond. The ultraviolet transmission is determined by the energy gap between the valance band and the conduction band. The conduction band states are relatively fixed since they correspond to the Si—O bond. The position of the valence band, or its maximum occupied orbital states, is largely derived from the positively charged modifier ions such as the alkali metal ions and the alkaline earth metal ions. The absorption is dependent on the energy gap between the conduction and valence band; the latter of which are dominated by the network modifiers, and optionally impurities such as Fe⁺³ and other transition metal ions. The Fe⁺³ is a common contaminant (“tramp”) coming from the impurities of the batch materials. To increase the transmission, one wants to widen this gap. Since the valence band is the practical band to influence, one must consider the nature of the modifier ion to oxygen ion bond. For example, the more ionic-like the bond (called nonbridging oxygen, or NBO), the stronger the interaction and the more it moves the valence band to a higher energy thus reducing the energy gap and making the transmission in the UV transmission less. On the other hand, the bonding of the oxygen to the alkaline-earth metal ions is less ionic and more covalent which results in the valence band shifting less, with respect to that of pure SiO₂, thus, increasing the UV transmission. The particular alkaline earth metal ion or the collection of them affects the position of the valence band, as does the oxidation state of the metal ion. For example, the energy state introduced by an Fe²⁺ impurity is closer to the valence band of SiO₂ than that of Fe³⁺. The alkaline earth compositions provide a more reducing environment as a result of the way the alkaline earth metals bond into the structure. The bonding of the alkaline earth metal ions in the lattice may play a role in determining this condition. In general, and without wishing to be bound by theory, the reasons for the higher UV transmission in alkaline earth metal-containing glass material disclosed herein may include the reduction of the Fe⁺³ to the non-absorbing Fe⁺² state and lack of nonbridging oxygen absorption.

The glass materials disclosed herein are characterized by a composition having a very low content of Fe(III) ions and/or Fe(III)-containing compounds. In some aspects, for example, glass materials disclosed herein are characterized by a composition comprising less than 0.1 wt. % (optionally less than or equal to 0.05 wt. %, optionally less than or equal to 0.01 wt. %, optionally less than or equal to 0.005 wt. %, optionally less than or equal to 0.001 wt. %) of Fc (III) or Fe³⁺ ions. In some aspects, for example, glass materials disclosed herein are characterized by a composition comprising less than 0.5 mol. % (optionally less than or equal to 0.2 mol. %, optionally less than or equal to 0.1 mol. %, optionally less than or equal to 0.05 mol. %, optionally less than or equal to 0.01 mol. %, optionally less than or equal to 0.005 mol. %, optionally less than or equal to 0.001 mol. %) of Fe(III) or Fe³⁺ ions. In some aspects, for example, glass materials disclosed herein are characterized by a composition comprising less than 0.05 wt. % (optionally less than or equal to 0.01 wt. %, optionally less than or equal to 0.005 wt. %, optionally less than or equal to 0.001 wt. %) of Fe₂O₃. Each of the foregoing numbers can be preceded by the word “about,” “at least about,” or “less than about,” and any of the foregoing numbers can be used singly to describe an open-ended range or in combination to describe a close-ended range.

Crystalline phases in glass materials may also be UV-absorbing centers, with some crystalline phases having a greater effect than others on reducing UV transmission through the glass material. In some aspects, for example, glass materials disclosed herein are amorphous materials, having very little total crystallinity. In some aspects, for example, glass materials disclosed herein comprise (or, compositions thereof comprise) a total content by weight of amorphous phase being greater than a total content by weight of crystalline phase. In some aspects, for example, glass materials disclosed herein comprise (or, compositions thereof comprise) a total crystallinity of less than 10 wt. %, optionally less than 7, wt. %, less than 5 wt. %, optionally less than 4 wt. %, optionally less than or equal to 3 wt. %, optionally less than or equal to 2 wt. %, optionally less than or equal to 1.5 wt. %, optionally less than or equal to 1 wt. %, optionally less than or equal to 0.5 wt. %, optionally less than or equal to 0.1 wt. %, optionally less than or equal to 0.05 wt. %, optionally less than or equal to 0.01 wt. %, optionally less than or equal to 0.001 wt. %.

In some aspects, for example, glass materials disclosed herein are, or compositions thereof are, free or substantially free of a cordierite crystal phase, a spinel crystal phase, a gahnite crystal phase, a mullite crystal phase, an anorhite crystal phase, a cristobalite crystal phase, or any combination of these. In some aspects, for example, glass materials disclosed herein are, or compositions thereof are, free or substantially free of a cordierite crystal phase, a spinel crystal phase, a gahnite crystal phase, a mullite crystal phase, an anorhite crystal phase, and a cristobalite crystal phase.

In some aspects, for example, glass materials disclosed herein are, or compositions thereof are, free or substantially free of a cordierite crystal phase

In some aspects, for example, glass materials disclosed herein comprise, or compositions thereof comprise, less than 10 wt. % (optionally less than or equal to 7 wt. %, optionally less than or equal to 5 wt. %, optionally less than or equal to 3 wt. %, optionally less than or equal to 2 wt. %, optionally less than or equal to 1 wt. %, optionally less than or equal to 0.5 wt. %, optionally less than or equal to 0.1 wt. %, optionally less than or equal to 0.05 wt. %, optionally less than or equal to 0.01 wt. %, optionally less than or equal to 0.005 wt. %, optionally less than or equal to 0.001 wt. %) of a cordierite crystal phase, a spinel crystal phase, a gahnite crystal phase, a mullite crystal phase, an anorhite crystal phase, a cristobalite crystal phase, or any combination of these (e.g., a combination of all of these).

In some aspects, for example, glass materials disclosed herein comprise, or compositions thereof comprise, less than 10 wt. % (optionally less than or equal to 7 wt. %, optionally less than or equal to 5 wt. %, optionally less than or equal to 3 wt. %, optionally less than or equal to 2 wt. %, optionally less than or equal to 1 wt. %, optionally less than or equal to 0.5 wt. %, optionally less than or equal to 0.1 wt. %, optionally less than or equal to 0.05 wt. %, optionally less than or equal to 0.01 wt. %, optionally less than or equal to 0.005 wt. %, optionally less than or equal to 0.001 wt. %) of a cordierite crystal phase. In some aspects, for example, glass materials disclosed herein comprise, or compositions thereof comprise, less than 10 wt. % (optionally less than or equal to 7 wt. %, optionally less than or equal to 5 wt. %, optionally less than or equal to 3 wt. %, optionally less than or equal to 2 wt. %, optionally less than or equal to 1 wt. %, optionally less than or equal to 0.5 wt. %, optionally less than or equal to 0.1 wt. %, optionally less than or equal to 0.05 wt. %, optionally less than or equal to 0.01 wt. %, optionally less than or equal to 0.005 wt. %, optionally less than or equal to 0.001 wt. %) of any crystal phase. Each of the foregoing numbers can be preceded by the word “about,” “at least about,” or “less than about,” and any of the foregoing numbers can be used singly to describe an open-ended range or in combination to describe a close-ended range.

In some aspects, certain other elements or compounds therewith may be detrimental to transmission of UV light through glass materials. In some aspects, for example, the glass material is characterized by a composition comprising, on an oxide basis, less than 0.5 wt. %, less than 0.1 wt. %, or less than 0.01 wt. % of tin oxide, and/or less than 0.5 wt. %, less than 0.1 wt. %, or less than 0.01 wt. % of zinc oxide. In some aspects, for example, the glass material is characterized by a composition comprising, on an oxide basis, less than 0.01 mol. % of tin oxide and/or less than 0.01 mol. % of zinc oxide. In some aspects, for example, the glass material is characterized by a composition comprising, on an oxide basis, less than 1 wt. %, less than 0.5 wt. %, or less than 0.1 mol. % of the sum of cesium oxide, antimony oxide, and tin oxide. In some aspects, for example, the glass material is characterized by a composition comprising, on an oxide basis, less than 1 wt. %, less than 0.5 wt. %, or less than 0.1 wt. % of the sum of cesium oxide, antimony oxide, and tin oxide. In some aspects, for example, the glass material is characterized by a composition comprising, on an oxide basis, less than 1 wt. %, less than 0.5 wt. %, or less than 0.1 wt. % (optionally less than 0.05 wt. %, optionally less than 0.01 wt. %) of the sum of cesium oxide, antimony oxide, and tin oxide. Each of the foregoing numbers can be preceded by the word “about,” “at least about,” or “less than about,” and any of the foregoing numbers can be used singly to describe an open-ended range or in combination to describe a close-ended range.

Glass materials disclosed herein may be formed into and/or included in glass-based articles and/or glass-containing devices. A glass-based article may be, for example, but is not limited to a glass substrate having other glass and/or non-glass materials disposed thereon, such as a glass substrate having metal, polymer, and/or semiconductor material(s) deposited thereon. A glass-based article may be, for example, but is not limited to a laminate of glass and non-glass material(s), a laminate of glass and crystalline material(s), a laminate of glass and glass-ceramic(s), or any combination thereof. A device may be an electronic or electrochemical device, for example, such as, but not limited to, a battery cell, a photovoltaic cell, a photochromic cell or window, etc. having glass(es) and/or glass-based article(s), such as in the form of a glass substrate being or comprising a glass material according to aspects disclosed herein.

### Formation of Glass Materials and Related Techniques:

In some aspects, glass materials described herein are formed and/or are formable by down-draw processes that are known in the art, such as slot-draw and fusion-draw processes. However, if desired, any other method known in the art can be used to prepare the glass materials described herein, such as by using a crucible melt method.

In aspects, the glass materials described herein may be formed by a down-draw process. Down-draw processes produce glass materials having a uniform thickness that possess relatively pristine surfaces. Because the average flexural strength of the glass material is controlled at least in part by the amount and size of surface flaws, a pristine surface that has had minimal contact has a higher initial strength. In addition, down drawn glass materials have a very flat, smooth surface that can be used in its final application without costly grinding and polishing. However, if desired, additional grinding and/or polish may be employed for certain applications.

The fusion draw process is an industrial technique that has been used for the large-scale manufacture of thin glass sheets. Compared to other flat glass manufacturing techniques, such as the float or slot draw processes, the fusion draw process yields thin glass sheets with superior flatness and surface quality. As a result, the fusion draw process has become the dominant manufacturing technique in the fabrication of thin glass substrates for liquid crystal displays, as well as for cover glass for personal electronic devices such as notebooks, entertainment devices, tablets, laptops, smartphones, and the like.

For example, the glass materials of the present disclosure may be formed using a fusion drawing process (i.e., are fusion-formable). A conventional fusion drawing process uses a drawing tank that has a channel for accepting molten glass raw material. The channel has weirs that are open at the top along the length of the channel on both sides of the channel. When the channel fills with molten material, the molten glass overflows the weirs. Due to gravity, the molten glass flows down the outside surfaces of the drawing tank as two flowing glass films. These outside surfaces of the drawing tank extend down and inwardly so that they join at an edge below the drawing tank. The two flowing glass films join at this edge to fuse and form a single flowing glass material. The fusion drawing process offers the advantage that, because the two glass films flowing over the channel fuse together, neither of the outside surfaces of the resulting glass comes in contact with any part of the apparatus. Thus, due to the lack of contact, the outside surfaces of the fusion drawn glass material are generally considered to be smooth and flat and can often be used without additional grinding or polishing.

In some aspects, the glass materials described herein may be formed by a slot draw process. The slot draw process is distinct from the fusion draw method. In slot draw processes, the molten raw material glass is provided to a drawing tank. The bottom of the drawing tank has an open slot with a nozzle that extends the length of the slot. The molten glass flows through the slot/nozzle and is drawn downward as a continuous glass material and into an annealing region.

A glass material or article thereof may be characterized by the manner in which it is formed. For instance, the glass material or article thereof may be characterized as float-formable (i.e., formed by a float process), down-drawable and, in particular, fusion-formable or slot-drawable (i.e., formed by a down draw process such as a fusion draw process or a slot draw process). In order to be fusion drawable, a glass material should have a sufficiently high liquidus viscosity. In some aspects, the glass materials described herein have a liquidus viscosity of at least about 120 kilopoise (kpoise), for example.

Exemplary specific conditions, parameters, steps, sequence of steps, equipment, requirements, tolerances, etc., related to manufacturing these glass materials are optionally about, substantially equivalent to, or equal to any of those provided in any of the following US patent documents, each of which is incorporated herein by reference to the extent not inconsistent herewith: U.S. Pat. Nos. 11,542,193, 11,577,987, 11,584,681, US Pat. Pub. 2020/0339468, U.S. Pat. No. 10,787,387, 9,878,940, US Pat. Pub. 2019/0047898, U.S. Pat. No. 9,919,951, 11,554,982, 11,591,249, US Pat. Pub. 2023/0015444, US Pat. Pub. 2023/0017932, US Pat. Pub. 2023/0027062, US Pat. Pub. 2023/0056119, US Pat. Pub. 2023/0057346, U.S. Pat. No. 9,540,278, and US Pat. Pub. 2016/036881.

### Certain Exemplary Aspects and Embodiments

Various aspects are contemplated herein, several of which are set forth in the paragraphs below. It is explicitly contemplated that any aspect or portion thereof can be combined to form an aspect. In addition, it is explicitly contemplated that: any reference to Aspect 1 includes reference to Aspects 1a, 1b, 1c, and/or 1d, etc., and any combination thereof; any reference to Aspect 4 includes reference to Aspects 4a, 4b, and 4c, and so on (any reference to an aspect includes reference to that aspect's lettered versions). Moreover, the terms “any preceding aspect” and “any one of the preceding aspects” means any aspect that appears prior to the aspect that contains such phrase (for example, the sentence “Aspect 32: The glass material, article, sheet, or method of any one of the preceding Aspects . . . ” means that any aspect prior to aspect 32 is referenced, including letter versions, including aspects 1a through 31). For example, it is contemplated that, optionally, any composition, glass material, sheet, glass-based article or device, or method of any the below aspects may be useful with or combined with any other aspect provided below. Further, for example, it is contemplated that any embodiment or aspect described above may, optionally, be combined with any one or more of the below listed aspects or any portion(s) thereof.

Aspect 1a: A glass material comprising:
a composition comprising, on an oxide basis:
   silica selected from the range of 55 mol. % (optionally 57 mol. %, optionally 58 mol. %, optionally 59 mol. %, optionally 60 mol. %, optionally 62 mol. %, optionally 63 mol. %, optionally 64 mol. %, optionally 65 mol. %, optionally 66 mol. %, optionally 67 mol. %, optionally 68 mol. %) to 75 mol. % (optionally 70 mol. %, optionally 71 mol. %, optionally 72 mol. %, optionally 73 mol. %, optionally 74 mol. %);
   alumina selected from the range of 1 mol. % (optionally 4 mol. %, optionally 5 mol. %, optionally 6 mol. %, optionally 6.5 mol. %, optionally 7 mol. %, optionally 7.5 mol. %, optionally 8 mol. %, optionally 8.5 mol. %, optionally 9 mol. %) to 20 mol. % (optionally 18 mol. %, optionally 16 mol. %, optionally 15 mol. %, optionally 12 mol. %, optionally 11 mol. %, optionally 10.5 mol. %, optionally 10 mol. %); and
   boric oxide selected from the range of 10 mol. % (optionally 10.5 mol. %, optionally 11 mol. %, optionally 11.5 mol. %, optionally 12 mol. %, optionally 12.5 mol. %, optionally 13 mol. %, optionally 13.5 mol. %) to 20 mol. % (optionally 19 mol. %, optionally 18.5 mol. %, optionally 18 mol. %, optionally 17.5 mol. %, optionally 17 mol. %, optionally 16.5 mol. %, optionally 16 mol. %);
wherein the composition comprises an RO/Al₂O₃ ratio, on an oxide basis, selected from the range of 0.80 (optionally 0.83, optionally 0.84, optionally 0.85, optionally 0.86, optionally 0.87, optionally 0.9, optionally 0.92, optionally 0.95, optionally 0.98, optionally 1.0) to 3.5 (optionally 1.25, optionally 1.3, optionally 1.35, optionally 1.4, optionally 1.45, optionally 1.5, optionally 1.7, optionally 1.9, optionally 2.0, optionally 2.5, optionally 3.0), the term RO being the mol. % sum of MgO, CaO, SrO, and BaO;
wherein the glass material comprises a total content by weight of amorphous phase being greater than a total content by weight of crystalline phase; and
wherein the glass material is characterized by a light transmission of at least 50% (optionally at least 55%, optionally at least 60%, optionally at least 65%, optionally at least 70%, optionally selected from the range of 50% to 80%, optionally selected from the range of 55% to 80%, optionally selected from the range of 60% to 80%, optionally selected from the range of 65% to 80%, optionally selected from the range of 70% to 80%) at a wavelength selected from the range of about 245 nm to about 270 nm (optionally at a wavelength selected from the range of about 248 nm to about 266 nm, optionally at a wavelength selected from the range of about 245 nm to about 255 nm, optionally at 248 nm, optionally at all wavelengths selected from the range of about 245 nm to about 270 nm, optionally at all wavelengths selected from the range of about 248 nm to about 266 nm, optionally at all wavelengths selected from the range of about 245 nm to about 255 nm) when the glass material is in the form of a sheet having a thickness selected from the range of about 0.3 mm to about 1 mm (optionally a thickness of about 0.3 mm, optionally a thickness of about 0.5 mm, optionally a thickness of about 0.7 mm, optionally a thickness of about 1.0 mm).

Aspect 1b: A glass article having a glass material comprising:
a composition comprising, on an oxide basis:
   silica selected from the range of 55 mol. % (optionally 57 mol. %, optionally 58 mol. %, optionally 59 mol. %, optionally 60 mol. %, optionally 62 mol. %, optionally 63 mol. %, optionally 64 mol. %, optionally 65 mol. %, optionally 66 mol. %, optionally 67 mol. %, optionally 68 mol. %) to 75 mol. % (optionally 70 mol. %, optionally 71 mol. %, optionally 72 mol. %, optionally 73 mol. %, optionally 74 mol. %);
   alumina selected from the range of 1 mol. % (optionally 4 mol. %, optionally 5 mol. %, optionally 6 mol. %, optionally 6.5 mol. %, optionally 7 mol. %, optionally 7.5 mol. %, optionally 8 mol. %, optionally 8.5 mol. %, optionally 9 mol. %) to 20 mol. % (optionally 18 mol. %, optionally 16 mol. %, optionally 15 mol. %, optionally 12 mol. %, optionally 11 mol. %, optionally 10.5 mol. %, optionally 10 mol. %); and
   boric oxide selected from the range of 10 mol. % (optionally 10.5 mol. %, optionally 11 mol. %, optionally 11.5 mol. %, optionally 12 mol. %, optionally 12.5 mol. %, optionally 13 mol. %, optionally 13.5 mol. %) to 20 mol. % (optionally 19 mol. %, optionally 18.5 mol. %, optionally 18 mol. %, optionally 17.5 mol. %, optionally 17 mol. %, optionally 16.5 mol. %, optionally 16 mol. %);
wherein the composition comprises an RO/Al₂O₃ ratio, on an oxide basis, selected from the range of 0.80 (optionally 0.83, optionally 0.84, optionally 0.85, optionally 0.86, optionally 0.87, optionally 0.9, optionally 0.92, optionally 0.95, optionally 0.98, optionally 1.0) to 3.5 (optionally 1.25, optionally 1.3, optionally 1.35, optionally 1.4, optionally 1.45, optionally 1.5, optionally 1.7, optionally 1.9, optionally 2.0, optionally 2.5, optionally 3.0), the term RO being the mol. % sum of MgO, CaO, SrO, and BaO;
wherein the glass material comprises a total content by weight of amorphous phase being greater than a total content by weight of crystalline phase; and
wherein the glass material is characterized by a light transmission of at least 50% (optionally at least 55%, optionally at least 60%, optionally at least 65%, optionally at least 70%, optionally selected from the range of 50% to 80%, optionally selected from the range of 55% to 80%, optionally selected from the range of 60% to 80%, optionally selected from the range of 65% to 80%, optionally selected from the range of 70% to 80%) at a wavelength selected from the range of about 245 nm to about 270 nm (optionally at a wavelength selected from the range of about 248 nm to about 266 nm, optionally at a wavelength selected from the range of about 245 nm to about 255 nm, optionally at 248 nm, optionally at all wavelengths selected from the range of about 245 nm to about 270 nm, optionally at all wavelengths selected from the range of about 248 nm to about 266 nm, optionally at all wavelengths selected from the range of about 245 nm to about 255 nm) when the glass material is in the form of a sheet having a thickness selected from the range of about 0.3 mm to about 1 mm (optionally a thickness of about 0.3 mm, optionally a thickness of about 0.5 mm, optionally a thickness of about 0.7 mm, optionally a thickness of about 1.0 mm).

Aspect 1c: A glass sheet formed of a glass material comprising:
a composition comprising, on an oxide basis:
   silica selected from the range of 55 mol. % (optionally 57 mol. %, optionally 58 mol. %, optionally 59 mol. %, optionally 60 mol. %, optionally 62 mol. %, optionally 63 mol. %, optionally 64 mol. %, optionally 65 mol. %, optionally 66 mol. %, optionally 67 mol. %, optionally 68 mol. %) to 75 mol. % (optionally 70 mol. %, optionally 71 mol. %, optionally 72 mol. %, optionally 73 mol. %, optionally 74 mol. %);
   alumina selected from the range of 1 mol. % (optionally 4 mol. %, optionally 5 mol. %, optionally 6 mol. %, optionally 6.5 mol. %, optionally 7 mol. %, optionally 7.5 mol. %, optionally 8 mol. %, optionally 8.5 mol. %, optionally 9 mol. %) to 20 mol. % (optionally 18 mol. %, optionally 16 mol. %, optionally 15 mol. %, optionally 12 mol. %, optionally 11 mol. %, optionally 10.5 mol. %, optionally 10 mol. %); and
   boric oxide selected from the range of 10 mol. % (optionally 10.5 mol. %, optionally 11 mol. %, optionally 11.5 mol. %, optionally 12 mol. %, optionally 12.5 mol. %, optionally 13 mol. %, optionally 13.5 mol. %) to 20 mol. % (optionally 19 mol. %, optionally 18.5 mol. %, optionally 18 mol. %, optionally 17.5 mol. %, optionally 17 mol. %, optionally 16.5 mol. %, optionally 16 mol. %);
wherein the composition comprises an RO/Al₂O₃ ratio, on an oxide basis, selected from the range of 0.80 (optionally 0.83, optionally 0.84, optionally 0.85, optionally 0.86, optionally 0.87, optionally 0.9, optionally 0.92, optionally 0.95, optionally 0.98, optionally 1.0) to 3.5 (optionally 1.25, optionally 1.3, optionally 1.35, optionally 1.4, optionally 1.45, optionally 1.5, optionally 1.7, optionally 1.9, optionally 2.0, optionally 2.5, optionally 3.0), the term RO being the mol. % sum of MgO, CaO, SrO, and BaO;
wherein the glass material comprises a total content by weight of amorphous phase being greater than a total content by weight of crystalline phase; and
wherein the glass material is characterized by a light transmission of at least 50% (optionally at least 55%, optionally at least 60%, optionally at least 65%, optionally at least 70%, optionally selected from the range of 50% to 80%, optionally selected from the range of 55% to 80%, optionally selected from the range of 60% to 80%, optionally selected from the range of 65% to 80%, optionally selected from the range of 70% to 80%) at a wavelength selected from the range of about 245 nm to about 270 nm (optionally at a wavelength selected from the range of about 248 nm to about 266 nm, optionally at a wavelength selected from the range of about 245 nm to about 255 nm, optionally at 248 nm, optionally at all wavelengths selected from the range of about 245 nm to about 270 nm, optionally at all wavelengths selected from the range of about 248 nm to about 266 nm, optionally at all wavelengths selected from the range of about 245 nm to about 255 nm) when the glass material is in the form of a sheet having a thickness selected from the range of about 0.3 mm to about 1 mm (optionally a thickness of about 0.3 mm, optionally a thickness of about 0.5 mm, optionally a thickness of about 0.7 mm, optionally a thickness of about 1.0 mm).

Aspect 1d: A method of making a glass material, the method comprising:
providing a precursor composition comprising silica, alumina, boric acid, and at least one of magnesium oxide, calcium oxide, strontium oxide, and barium oxide; and
forming the glass material from a precursor composition using a down-draw process;
wherein the glass material comprises:
   a composition comprising, on an oxide basis:
   silica selected from the range of 55 mol. % (optionally 57 mol. %, optionally 58 mol. %, optionally 59 mol. %, optionally 60 mol. %, optionally 62 mol. %, optionally 63 mol. %, optionally 64 mol. %, optionally 65 mol. %, optionally 66 mol. %, optionally 67 mol. %, optionally 68 mol. %) to 75 mol. % (optionally 70 mol. %, optionally 71 mol. %, optionally 72 mol. %, optionally 73 mol. %, optionally 74 mol. %);
   alumina selected from the range of 1 mol. % (optionally 4 mol. %, optionally 5 mol. %, optionally 6 mol. %, optionally 6.5 mol. %, optionally 7 mol. %, optionally 7.5 mol. %, optionally 8 mol. %, optionally 8.5 mol. %, optionally 9 mol. %) to 20 mol. % (optionally 18 mol. %, optionally 16 mol. %, optionally 15 mol. %, optionally 12 mol. %, optionally 11 mol. %, optionally 10.5 mol. %, optionally 10 mol. %); and
   boric oxide selected from the range of 10 mol. % (optionally 10.5 mol. %, optionally 11 mol. %, optionally 11.5 mol. %, optionally 12 mol. %, optionally 12.5 mol. %, optionally 13 mol. %, optionally 13.5 mol. %) to 20 mol. % (optionally 19 mol. %, optionally 18.5 mol. %, optionally 18 mol. %, optionally 17.5 mol. %, optionally 17 mol. %, optionally 16.5 mol. %, optionally 16 mol. %);
   wherein the composition comprises an RO/Al₂O₃ ratio, on an oxide basis, selected from the range of 0.80 (optionally 0.83, optionally 0.84, optionally 0.85, optionally 0.86, optionally 0.87, optionally 0.9, optionally 0.92, optionally 0.95, optionally 0.98, optionally 1.0) to 3.5 (optionally 1.25, optionally 1.3, optionally 1.35, optionally 1.4, optionally 1.45, optionally 1.5, optionally 1.7, optionally 1.9, optionally 2.0, optionally 2.5, optionally 3.0), the term RO being the mol. % sum of MgO, CaO, SrO, and BaO;
   wherein the glass material comprises a total content by weight of amorphous phase being greater than a total content by weight of crystalline phase; and
   wherein the glass material is characterized by a light transmission of at least 50% (optionally at least 55%, optionally at least 60%, optionally at least 65%, optionally at least 70%, optionally selected from the range of 50% to 80%, optionally selected from the range of 55% to 80%, optionally selected from the range of 60% to 80%, optionally selected from the range of 65% to 80%, optionally selected from the range of 70% to 80%) at a wavelength selected from the range of about 245 nm to about 270 nm (optionally at a wavelength selected from the range of about 248 nm to about 266 nm, optionally at a wavelength selected from the range of about 245 nm to about 255 nm, optionally at 248 nm, optionally at all wavelengths selected from the range of about 245 nm to about 270 nm, optionally at all wavelengths selected from the range of about 248 nm to about 266 nm, optionally at all wavelengths selected from the range of about 245 nm to about 255 nm) when the glass material is in the form of a sheet having a thickness selected from the range of about 0.3 mm to about 1 mm (optionally a thickness of about 0.3 mm, optionally a thickness of about 0.5 mm, optionally a thickness of about 0.7 mm, optionally a thickness of about 1.0 mm).

Aspect 2: The glass material, article, sheet, or method of any one of the preceding Aspects, the glass material comprising a total crystallinity of less than 5 wt. %, optionally less than 4 wt. %, optionally less than or equal to 3 wt. %, optionally less than or equal to 2 wt. %, optionally less than or equal to 1.5 wt. %, optionally less than or equal to 1 wt. %, optionally less than or equal to 0.5 wt. %, optionally less than or equal to 0.1 wt. %, optionally less than or equal to 0.05 wt. %, optionally less than or equal to 0.01 wt. %, optionally less than or equal to 0.001 wt. %.

Aspect 3a: The glass material, article, sheet, or method of any one of the preceding Aspects, wherein the glass material is characterized by an average light transmission of at least 50% (optionally at least 55%, optionally at least 60%, optionally at least 65%, optionally at least 70%, optionally selected from the range of 50% to 80%, optionally selected from the range of 55% to 80%, optionally selected from the range of 60% to 80%, optionally selected from the range of 65% to 80%, optionally selected from the range of 70% to 80%) throughout a wavelength range being about 245 nm to about 270 nm (optionally about 248 nm to about 266 nm, optionally about 245 nm to about 255 nm) when the glass material is in the form of a sheet having a thickness selected from the range of about 0.3 mm to about 1 mm (optionally a thickness of about 0.3 mm, optionally a thickness of about 0.5 mm, optionally a thickness of about 0.7 mm, optionally a thickness of about 1.0 mm). Aspect 3b: The glass material, article, sheet, or method of any one of the preceding Aspects, wherein the glass material is characterized by a light transmission of at least 50% (optionally at least 55%, optionally at least 60%, optionally at least 65%, optionally at least 70%, optionally selected from the range of 50% to 80%, optionally selected from the range of 55% to 80%, optionally selected from the range of 60% to 80%, optionally selected from the range of 65% to 80%, optionally selected from the range of 70% to 80%) throughout a wavelength range being about 245 nm to about 270 nm (optionally about 248 nm to about 266 nm, optionally about 245 nm to about 255 nm) when the glass material is in the form of a sheet having a thickness selected from the range of about 0.3 mm to about 1 mm (optionally a thickness of about 0.3 mm, optionally a thickness of about 0.5 mm, optionally a thickness of about 0.7 mm, optionally a thickness of about 1.0 mm). Aspect 3c: The glass material, article, sheet, or method of any one of the preceding Aspects, wherein the glass material is characterized by a light transmission of at least 50% (optionally at least 55%, optionally at least 60%, optionally at least 65%, optionally at least 70%, optionally selected from the range of 50% to 80%, optionally selected from the range of 55% to 80%, optionally selected from the range of 60% to 80%, optionally selected from the range of 65% to 80%, optionally selected from the range of 70% to 80%) at a majority of wavelengths in a wavelength range being about 245 nm to about 270 nm (optionally about 248 nm to about 266 nm, optionally about 245 nm to about 255 nm) when the glass material is in the form of a sheet having a thickness selected from the range of about 0.3 mm to about 1 mm (optionally a thickness of about 0.3 mm, optionally a thickness of about 0.5 mm, optionally a thickness of about 0.7 mm, optionally a thickness of about 1.0 mm). Aspect 3d: The glass material, article, sheet, or method of any one of the preceding Aspects, wherein the glass material is characterized by a light transmission of at least 50% (optionally at least 55%, optionally at least 60%, optionally at least 65%, optionally at least 70%, optionally selected from the range of 50% to 80%, optionally selected from the range of 55% to 80%, optionally selected from the range of 60% to 80%, optionally selected from the range of 65% to 80%, optionally selected from the range of 70% to 80%) of light having a wavelength of 248 nm, 254 nm, and/or 266 nm when the glass material is in the form of a sheet having a 1 mm thickness (optionally a 0.7 mm thickness, optionally a 0.5 mm thickness, optionally a 0.3 mm thickness).

Aspect 4a: The glass material, article, sheet, or method of any one of the preceding Aspects, wherein the composition is free of F. Aspect 4b: The glass material, article, sheet, or method of any one of the preceding Aspects, wherein the composition comprises less than 0.2 wt. %, 0.7 mol %, or 2000 ppm by weight of F. Aspect 4c: The glass material, article, sheet, or method of any one of the preceding Aspects, wherein the composition comprises less than 0.2 wt. % (optionally less than 0.1 wt. %, optionally less than 0.0.1 wt. %, optionally less than 0.001 wt. %) of F. Aspect 4d: The glass material, article, sheet, or method of any one of the preceding Aspects, wherein the composition comprises less than 0.7 mol. % (optionally less than 0.5 mol. %, optionally less than 0.1 mol. %, optionally less than 0.05 mol. %, optionally less than 0.01 mol. %) of F.

Aspect 5a: The glass material, article, sheet, or method of any one of the preceding Aspects, wherein the glass material is formed from a precursor composition free of or substantially free of one or more metal fluorides. Aspect 5b: The glass material, article, sheet, or method of any one of the preceding Aspects, wherein the glass material is formed from a precursor composition having less than 5 wt. % (optionally less than 2 wt. %, optionally less than 1 wt. %, optionally less than 0.1 wt. %, optionally less than 0.01 wt. %, optionally less than 0.001 wt. %, optionally less than 0.0001 wt. %) of one or more metal fluorides.

Aspect 6a: The glass material, article, sheet, or method of any one of the preceding Aspects, wherein the composition is free or substantially free of alkali metals. Aspect 6b: The glass material, article, sheet, or method of any one of the preceding Aspects, wherein the composition comprises a sum of Li₂O, Na₂O, K₂O, Rb₂O and Cs₂O being less than or equal to 0.5 mol. % (optionally less than or equal to 0.3 mol. %, less than or equal to 0.1 mol. %, optionally less than or equal to 0.05 mol. %, optionally less than or equal to 0.01 mol. %, optionally less than or equal to 0.001 mol. %). Aspect 6c: The glass material, article, sheet, or method of any one of the preceding Aspects, wherein the composition comprises a sum of Li₂O, Na₂O, K₂O, Rb₂O and Cs₂O being less than or equal to 0.2 wt. % (optionally less than or equal to 0.1 wt. %, less than or equal to 0.05 wt. %, optionally less than or equal to 0.01 wt. %, optionally less than or equal to 0.005 wt. %, optionally less than or equal to 0.001 wt. %).

Aspect 7a: The glass material, article, sheet, or method of any one of the preceding Aspects, wherein the composition comprises less than 0.1 wt. % (optionally less than or equal to 0.05 wt. %, optionally less than or equal to 0.01 wt. %, optionally less than or equal to 0.005 wt. %, optionally less than or equal to 0.001 wt. %) of Fe(III) or Fe³⁺ ions. Aspect 7b: The glass material, article, sheet, or method of any one of the preceding Aspects, wherein the composition comprises less than 0.05 wt. % (optionally less than or equal to 0.01 wt. %, optionally less than or equal to 0.005 wt. %, optionally less than or equal to 0.001 wt. %) of Fe₂O₃.

Aspect 8: The glass material, article, sheet, or method of any one of the preceding Aspects, wherein the composition comprises a sum of SnO₂, ZnO, F, Cl, and C being less than 0.5 mol. % (optionally less than 0.4 mol. %, optionally less than 0.3 mol. %, optionally less than 0.2 mol. %, optionally less than 0.1 mol. %, optionally less than 0.05 mol. %).

Aspect 9: The glass material, article, sheet, or method of any one of the preceding Aspects, wherein the composition comprises C and is free of F and Cl.

Aspect 10a: The glass material, article, sheet, or method of any one of the preceding Aspects, wherein the composition is free or substantially free of a cordierite crystal phase, a spinel crystal phase, a gahnite crystal phase, a mullite crystal phase, an anorhite crystal phase, a cristobalite crystal phase, or any combination of these. Aspect 10b: The glass material, article, sheet, or method of any one of the preceding Aspects, wherein the composition is free or substantially free of a cordierite crystal phase, a spinel crystal phase, a gahnite crystal phase, a mullite crystal phase, an anorhite crystal phase, and a cristobalite crystal phase. Aspect 10c: The glass material, article, sheet, or method of any one of the preceding Aspects, wherein the composition is free or substantially free of a cordierite crystal phase. Aspect 10d: The glass material, article, sheet, or method of any one of the preceding Aspects, wherein the composition has less than 5 wt. % (optionally less than or equal to 3 wt. %, optionally less than or equal to 2 wt. %, optionally less than or equal to 1 wt. %, optionally less than or equal to 0.5 wt. %, optionally less than or equal to 0.1 wt. %, optionally less than or equal to 0.05 wt. %, optionally less than or equal to 0.01 wt. %, optionally less than or equal to 0.005 wt. %, optionally less than or equal to 0.001 wt. %) of a cordierite crystal phase, a spinel crystal phase, a gahnite crystal phase, a mullite crystal phase, an anorhite crystal phase, a cristobalite crystal phase, or any combination of these. Aspect 10c: The glass material, article, sheet, or method of any one of the preceding Aspects, wherein the composition has less than 5 wt. % (optionally less than or equal to 3 wt. %, optionally less than or equal to 2 wt. %, optionally less than or equal to 1 wt. %, optionally less than or equal to 0.5 wt. %, optionally less than or equal to 0.1 wt. %, optionally less than or equal to 0.05 wt. %, optionally less than or equal to 0.01 wt. %, optionally less than or equal to 0.005 wt. %, optionally less than or equal to 0.001 wt. %) of a cordierite crystal phase, a spinel crystal phase, a gahnite crystal phase, a mullite crystal phase, an anorhite crystal phase, and a cristobalite crystal phase. Aspect 10f: The glass material, article, sheet, or method of any one of the preceding Aspects, wherein the composition has less than 5 wt. % (optionally less than or equal to 3 wt. %, optionally less than or equal to 2 wt. %, optionally less than or equal to 1 wt. %, optionally less than or equal to 0.5 wt. %, optionally less than or equal to 0.1 wt. %, optionally less than or equal to 0.05 wt. %, optionally less than or equal to 0.01 wt. %, optionally less than or equal to 0.005 wt. %, optionally less than or equal to 0.001 wt. %) of a cordierite crystal phase. Aspect 10g: The glass material, article, sheet, or method of any one of the preceding Aspects, wherein the composition has less than 5 wt. % (optionally less than or equal to 3 wt. %, optionally less than or equal to 2 wt. %, optionally less than or equal to 1 wt. %, optionally less than or equal to 0.5 wt. %, optionally less than or equal to 0.1 wt. %, optionally less than or equal to 0.05 wt. %, optionally less than or equal to 0.01 wt. %, optionally less than or equal to 0.005 wt. %, optionally less than or equal to 0.001 wt. %) of any crystal phase.

Aspect 11: The glass material, article, sheet, or method of any one of the preceding Aspects, wherein the composition comprises a mol. % sum of Sr and Ba or a mol. % sum of Sr and Ca being greater than a mol. % sum of Mg and Ca.

Aspect 12: The glass material, article, sheet, or method of any one of the preceding Aspects, wherein the composition comprises an RO/(Al₂O₃+B₂O₃) ratio, on an oxide basis, selected from the range of 0.2 (optionally 0.25, optionally 0.28, optionally 0.3, optionally 0.32, optionally 0.35, optionally 0.4) to 0.65 (optionally 0.62, optionally 0.6, optionally 0.58, optionally 0.55, optionally 0.52, optionally 0.5, optionally 0.48, optionally 0.45), and wherein any value and range therebetween is explicitly contemplated and disclosed herein inclusively.

Aspect 13: The glass material, article, sheet, or method of any one of the preceding Aspects, wherein the composition comprises a mol. % ratio of SiO₂/B₂O₃ selected from the range of 3.2 (optionally 3.5, optionally 3.7, optionally 4.0) to 6.0 (optionally 5.8, optionally 5.5, optionally 5.2, optionally 5.0), and wherein any value and range therebetween is explicitly contemplated and disclosed herein inclusively.

Aspect 14: The glass material, article, sheet, or method of any one of the preceding Aspects, wherein the composition comprises RO selected from the range of 7.0 mol. % (optionally 7.5, optionally 8.0, optionally 8.2, optionally 8.4, optionally 8.5, optionally 8.6, optionally 8.8, optionally 9.0 mol. %) to 11.5 mol. % (optionally 11.0, optionally 10.5, optionally 10.0, optionally 9.5 mol. %), and wherein any value and range therebetween is explicitly contemplated and disclosed herein inclusively.

Aspect 15: The glass material, article, sheet, or method of any one of the preceding Aspects, wherein the composition comprises |RO−Al₂O₃| being selected from the range of 1.0 mol. % (optionally 1.3 mol. %) to 8.0 mol. % (optionally 7.7, optionally 7.5, optionally 7.0, optionally 6.5, optionally 6.0, optionally 5.5, optionally 5.0, optionally 4.5, optionally 4.0, optionally 3.5, optionally 3.0, optionally 2.5, optionally 2.0 mol. %), and wherein any value and range therebetween is explicitly contemplated and disclosed herein inclusively.

Aspect 16: The glass material, article, sheet, or method of any one of the preceding Aspects, wherein the composition comprises (B₂O₃)/2 being selected from the range of 6.0 mol. % (optionally 6.2, optionally 6.5, optionally 6.7, optionally 6.8 mol. %) to 11 mol. % (optionally 10.5, optionally 10.0, optionally 9.5, optionally 9.0, optionally 8.5, optionally 8.0 mol. %), and wherein any value and range therebetween is explicitly contemplated and disclosed herein inclusively.

Aspect 17: The glass material, article, sheet, or method of any one of the preceding Aspects, wherein the composition comprises a sum of SiO₂ and MgO being selected from the range of 55 mol. % (optionally 60 mol. %, optionally 62 mol. %, optionally 65 mol. %) to 80 mol. % (optionally 78 mol. %, optionally 75 mol. %), and wherein any value and range therebetween is explicitly contemplated and disclosed herein inclusively.

Aspect 18: The glass material, article, sheet, or method of any one of the preceding Aspects, wherein the composition comprises, on an oxide basis:
SiO₂ selected from the range of 60 mol. % to 72 mol. %;
Al₂O₃ selected from the range of 6 mol. % to 11 mol. %; and
B₂O₃ selected from the range of 11 mol. % to 18 mol. %.

Aspect 19: The glass material, article, sheet, or method of any one of the preceding Aspects, wherein the composition comprises the RO/Al₂O₃ ratio, on an oxide basis, being selected from the range of 0.80 to 1.35, and wherein any value and range therebetween is explicitly contemplated and disclosed herein inclusively.

Aspect 20: The glass material, article, sheet, or method of any one of the preceding Aspects, wherein the glass material is characterized by a light transmission of at least 60% of light having a wavelength of 248 nm, 254 nm, and/or 266 nm when the glass material is in the form of a sheet having a 1 mm thickness.

Aspect 21a: The glass material, article, sheet, or method of any one of the preceding Aspects, wherein the composition comprises, on an oxide basis:
magnesium oxide selected from the range of 0 mol. % (optionally greater than 0 mol. %, optionally greater than or equal to 0.04 mol. %, optionally greater than or equal to 0.1 mol. %, optionally greater than or equal to 1 mol. %, optionally greater than or equal to 2 mol. %, optionally greater than or equal to 3 mol. %, optionally greater than or equal to 4 mol. %, optionally greater than or equal to 5 mol. %) to 8 mol. % (optionally less than or equal to 7 mol. %, optionally less than or equal to 6 mol. %, optionally less than or equal to 5 mol. %, optionally less than or equal to 4 mol. %, optionally less than or equal to 3 mol. %, optionally less than or equal to 2 mol. %, optionally less than or equal to 1 mol. %);
calcium oxide selected from the range of 0 mol. % (optionally greater than 0 mol. %, optionally greater than or equal to 0.04 mol. %, optionally greater than or equal to 0.1 mol. %, optionally greater than or equal to 1 mol. %, optionally greater than or equal to 2 mol. %, optionally greater than or equal to 3 mol. %, optionally greater than or equal to 4 mol. %, optionally greater than or equal to 5 mol. %) to 8 mol. % (optionally less than or equal to 7 mol. %, optionally less than or equal to 6 mol. %, optionally less than or equal to 5 mol. %, optionally less than or equal to 4 mol. %, optionally less than or equal to 3 mol. %, optionally less than or equal to 2 mol. %, optionally less than or equal to 1 mol. %);
strontium oxide selected from the range of 0 mol. % (optionally greater than 0 mol. %, optionally greater than or equal to 0.04 mol. %, optionally greater than or equal to 0.1 mol. %, optionally greater than or equal to 1 mol. %, optionally greater than or equal to 2 mol. %, optionally greater than or equal to 3 mol. %, optionally greater than or equal to 4 mol. %, optionally greater than or equal to 5 mol. %) to 8 mol. % (optionally less than or equal to 7 mol. %, optionally less than or equal to 6 mol. %, optionally less than or equal to 5 mol. %, optionally less than or equal to 4 mol. %, optionally less than or equal to 3 mol. %, optionally less than or equal to 2 mol. %, optionally less than or equal to 1 mol. %); and/or
barium oxide selected from the range of 0 mol. % (optionally greater than 0 mol. %, optionally greater than or equal to 0.04 mol. %, optionally greater than or equal to 0.1 mol. %, optionally greater than or equal to 1 mol. %, optionally greater than or equal to 2 mol. %, optionally greater than or equal to 3 mol. %, optionally greater than or equal to 4 mol. %, optionally greater than or equal to 5 mol. %) to 8 mol. % (optionally less than or equal to 7 mol. %, optionally less than or equal to 6 mol. %, optionally less than or equal to 5 mol. %, optionally less than or equal to 4 mol. %, optionally less than or equal to 3 mol. %, optionally less than or equal to 2 mol. %, optionally less than or equal to 1 mol. %).

Aspect 21b: The glass material, article, sheet, or method of any one of the preceding Aspects, wherein the composition comprises, on an oxide basis: magnesium oxide selected from the range of 0 mol. % (optionally greater than 0 mol. %, optionally greater than or equal to 0.04 mol. %, optionally greater than or equal to 0.1 mol. %, optionally greater than or equal to 1 mol. %, optionally greater than or equal to 2 mol. %, optionally greater than or equal to 3 mol. %, optionally greater than or equal to 4 mol. %, optionally greater than or equal to 5 mol. %) to 8 mol. % (optionally less than or equal to 7 mol. %, optionally less than or equal to 6 mol. %, optionally less than or equal to 5 mol. %, optionally less than or equal to 4 mol. %, optionally less than or equal to 3 mol. %, optionally less than or equal to 2 mol. %, optionally less than or equal to 1 mol. %), and wherein any value and range therebetween is explicitly contemplated and disclosed herein inclusively. Aspect 21c: The glass material, article, sheet, or method of any one of the preceding Aspects, wherein the composition comprises, on an oxide basis: calcium oxide selected from the range of 0 mol. % (optionally greater than 0 mol. %, optionally greater than or equal to 0.04 mol. %, optionally greater than or equal to 0.1 mol. %, optionally greater than or equal to 1 mol. %, optionally greater than or equal to 2 mol. %, optionally greater than or equal to 3 mol. %, optionally greater than or equal to 4 mol. %, optionally greater than or equal to 5 mol. %) to 8 mol. % (optionally less than or equal to 7 mol. %, optionally less than or equal to 6 mol. %, optionally less than or equal to 5 mol. %, optionally less than or equal to 4 mol. %, optionally less than or equal to 3 mol. %, optionally less than or equal to 2 mol. %, optionally less than or equal to 1 mol. %), and wherein any value and range therebetween is explicitly contemplated and disclosed herein inclusively. Aspect 21d: The glass material, article, sheet, or method of any one of the preceding Aspects, wherein the composition comprises, on an oxide basis: strontium oxide selected from the range of 0 mol. % (optionally greater than 0 mol. %, optionally greater than or equal to 0.04 mol. %, optionally greater than or equal to 0.1 mol. %, optionally greater than or equal to 1 mol. %, optionally greater than or equal to 2 mol. %, optionally greater than or equal to 3 mol. %, optionally greater than or equal to 4 mol. %, optionally greater than or equal to 5 mol. %) to 8 mol. % (optionally less than or equal to 7 mol. %, optionally less than or equal to 6 mol. %, optionally less than or equal to 5 mol. %, optionally less than or equal to 4 mol. %, optionally less than or equal to 3 mol. %, optionally less than or equal to 2 mol. %, optionally less than or equal to 1 mol. %), and wherein any value and range therebetween is explicitly contemplated and disclosed herein inclusively. Aspect 21e: The glass material, article, sheet, or method of any one of the preceding Aspects, wherein the composition comprises, on an oxide basis: barium oxide selected from the range of 0 mol. % (optionally greater than 0 mol. %, optionally greater than or equal to 0.04 mol. %, optionally greater than or equal to 0.1 mol. %, optionally greater than or equal to 1 mol. %, optionally greater than or equal to 2 mol. %, optionally greater than or equal to 3 mol. %, optionally greater than or equal to 4 mol. %, optionally greater than or equal to 5 mol. %) to 8 mol. % (optionally less than or equal to 7 mol. %, optionally less than or equal to 6 mol. %, optionally less than or equal to 5 mol. %, optionally less than or equal to 4 mol. %, optionally less than or equal to 3 mol. %, optionally less than or equal to 2 mol. %, optionally less than or equal to 1 mol. %), and wherein any value and range therebetween is explicitly contemplated and disclosed herein inclusively.

Aspect 22: The glass material, article, sheet, or method of any one of the preceding Aspects, wherein the composition comprises, on an oxide basis:
tin oxide less than 0.01 wt. %; and/or
zinc oxide less than 0.01 wt. %.

Aspect 23: The glass material, article, sheet, or method of any one of the preceding Aspects, wherein the composition comprises:
chloride (Cl⁻) less than 0.2 wt. %, less than 0.37 mol. %, or less than 2000 ppm by weight; and/or
carbon (C) less than 0.02 wt. %, less than 0.1 mol. %, or less than 200 ppm by weight.

Aspect 24a: The glass material, article, sheet, or method of any one of the preceding Aspects, wherein the composition comprises a sum of cesium oxide, antimony oxide, and tin oxide being less than 0.1 mol. %. Aspect 24b: The glass material, article, sheet, or method of any one of the preceding Aspects, wherein the composition comprises a sum of cesium oxide, antimony oxide, and tin oxide being less than 0.1 wt. % (optionally 0.05 wt. %, optionally 0.01 wt. %).

Aspect 25: The glass material, article, sheet, or method of any one of the preceding Aspects, wherein the glass material is characterized by a Young's modulus selected from the range of 55 (optionally 60) to 75 (optionally 70) GPa, and wherein any value and range therebetween is explicitly contemplated and disclosed herein inclusively.

Aspect 26a: The glass material, article, sheet, or method of any one of the preceding Aspects, wherein the glass material is characterized by a liquidus viscosity greater than or equal to 100 kilopoise (kP) (optionally greater than or equal to 110 kP, optionally greater than or equal to 120 kP, optionally greater than or equal to 125 kP, optionally greater than or equal to 130 kP, optionally greater than or equal to 140 kP, greater than or equal to 145 kP, greater than or equal to 150 kP). Aspect 26b: The glass material, article, sheet, or method of any one of the preceding Aspects, wherein the glass material is characterized by a liquidus viscosity greater than or equal to 100 kilopoise (kP) (optionally greater than or equal to 110 kP, optionally greater than or equal to 120 kP, optionally greater than or equal to 125 kP, optionally greater than or equal to 130 kP, optionally greater than or equal to 140 kP, optionally greater than or equal to 145 kP, optionally greater than or equal to 150 kP, optionally greater than or equal to 160 kP, optionally greater than or equal to 170 kP, optionally greater than or equal to 180 kP, optionally greater than or equal to 190 kP, optionally greater than or equal to 200 kP) and less than or equal to 500000 kP (optionally less than or equal to 200000 kP, optionally less than or equal to 100000 kP, optionally less than or equal to 50000 kP, optionally less than or equal to 20000 kP, optionally less than or equal to 10000 kP, optionally less than or equal to 5000 kP, optionally less than or equal to 2000 kP, optionally less than or equal to 1000 kP).

Aspect 27: The glass material, article, sheet, or method of any one of the preceding Aspects, wherein the glass material is characterized by a liquidus internal temperature selected from the range of 900 to 1100° C., and wherein any value and range therebetween is explicitly contemplated and disclosed herein inclusively.

Aspect 28a: The glass material, article, sheet, or method of any one of the preceding Aspects, wherein the glass material is characterized by a coefficient of thermal expansion (CTE) selected from the range of 28·10⁻⁷ to 40·10⁻⁷° C.⁻¹ (units) at a temperature selected from the range of 20° C. to 350° C., and wherein any value and range therebetween is explicitly contemplated and disclosed herein inclusively. Aspect 28b: The glass material, article, sheet, or method of any one of the preceding Aspects, wherein the glass material is characterized by a coefficient of thermal expansion (CTE) selected from the range of 2.8 to 4.0 ppm/° C. at a temperature selected from the range of 20° C. to 350° C., and wherein any value and range therebetween is explicitly contemplated and disclosed herein inclusively.

Aspect 29: The glass material, article, sheet, or method of any one of the preceding Aspects, wherein the glass material is characterized by a softening point selected from the range of 800 to 1100° C., and wherein any value and range therebetween is explicitly contemplated and disclosed herein inclusively.

Aspect 30: The glass material, article, sheet, or method of any one of the preceding Aspects, the glass material being characterized by a liquidus viscosity being greater than its forming viscosity.

Aspect 31: The glass material, article, sheet, or method of any one of the preceding Aspects, wherein the glass material is formed from a precursor composition free of one or more metal fluoride compounds, one or more metal chloride compounds, one or more tin-containing compounds, one or more iron-containing compounds, one or more zinc-containing compounds, or any combination thereof.

Aspect 32: The glass material, article, sheet, or method of any one of the preceding Aspects, wherein the glass material is formed from a precursor composition characterized by an electrical resistivity less than or equal to 180 Ω·in. at 1500° C. and/or less than or equal to 85 Ω·in. at 1600° C.

Aspect 33: The glass material, article, sheet, or method of any one of the preceding Aspects, the glass material being a fusion-formable glass material.

Aspect 34: A glass-based article or device comprising the glass material of any one of the preceding claims. A glass-based article may be, for example, but is not limited to a glass substrate having other glass and/or non-glass materials disposed thereon, such as a glass substrate having metal, polymer, and/or semiconductor material(s) deposited thereon. A glass-based article may be, for example, but is not limited to a laminate of glass and non-glass material(s), a laminate of glass and crystalline material(s), and a laminate of glass and glass-ceramic(s). A device may be an electronic or electrochemical device, for example, such as, but not limited to, a battery cell, a photovoltaic cell, a photochromic cell or window, etc. having glass(es) and/or glass-based article(s), such as in the form of a glass substrate being or comprising a glass material according to aspects disclosed herein.

Aspect 35: A method of making a glass material, the method comprising:
providing a precursor composition comprising silica, alumina, boric acid, and at least one of magnesium oxide, calcium oxide, strontium oxide, and barium oxide; and
forming the glass material from a precursor composition using a down-draw process;
wherein the glass material comprises:
   a composition comprising, on an oxide basis:
   silica selected from the range of 55 mol. % (optionally 57 mol. %, optionally 58 mol. %, optionally 59 mol. %, optionally 60 mol. %, optionally 62 mol. %, optionally 63 mol. %, optionally 64 mol. %, optionally 65 mol. %, optionally 66 mol. %, optionally 67 mol. %, optionally 68 mol. %) to 75 mol. % (optionally 70 mol. %, optionally 71 mol. %, optionally 72 mol. %, optionally 73 mol. %, optionally 74 mol. %);
   alumina selected from the range of 1 mol. % (optionally 4 mol. %, optionally 5 mol. %, optionally 6 mol. %, optionally 6.5 mol. %, optionally 7 mol. %, optionally 7.5 mol. %, optionally 8 mol. %, optionally 8.5 mol. %, optionally 9 mol. %) to 20 mol. % (optionally 18 mol. %, optionally 16 mol. %, optionally 15 mol. %, optionally 12 mol. %, optionally 11 mol. %, optionally 10.5 mol. %, optionally 10 mol. %); and
   boric oxide selected from the range of 10 mol. % (optionally 10.5 mol. %, optionally 11 mol. %, optionally 11.5 mol. %, optionally 12 mol. %, optionally 12.5 mol. %, optionally 13 mol. %, optionally 13.5 mol. %) to 20 mol. % (optionally 19 mol. %, optionally 18.5 mol. %, optionally 18 mol. %, optionally 17.5 mol. %, optionally 17 mol. %, optionally 16.5 mol. %, optionally 16 mol. %);
   wherein the composition comprises an RO/Al₂O₃ ratio, on an oxide basis, selected from the range of 0.80 (optionally 0.83, optionally 0.84, optionally 0.85, optionally 0.86, optionally 0.87, optionally 0.9, optionally 0.92, optionally 0.95, optionally 0.98, optionally 1.0) to 3.5 (optionally 1.25, optionally 1.3, optionally 1.35, optionally 1.4, optionally 1.45, optionally 1.5, optionally 1.7, optionally 1.9, optionally 2.0, optionally 2.5, optionally 3.0), the term RO being the mol. % sum of MgO, CaO, SrO, and BaO;
   wherein the glass material comprises a total content by weight of amorphous phase being greater than a total content by weight of crystalline phase; and
   wherein the glass material is characterized by a light transmission of at least 50% (optionally at least 55%, optionally at least 60%, optionally at least 65%, optionally at least 70%, optionally selected from the range of 50% to 80%, optionally selected from the range of 55% to 80%, optionally selected from the range of 60% to 80%, optionally selected from the range of 65% to 80%, optionally selected from the range of 70% to 80%) at a wavelength selected from the range of about 245 nm to about 270 nm (optionally at a wavelength selected from the range of about 248 nm to about 266 nm, optionally at a wavelength selected from the range of about 245 nm to about 255 nm, optionally at 248 nm, optionally at all wavelengths selected from the range of about 245 nm to about 270 nm, optionally at all wavelengths selected from the range of about 248 nm to about 266 nm, optionally at all wavelengths selected from the range of about 245 nm to about 255 nm) when the glass material is in the form of a sheet having a thickness selected from the range of about 0.3 mm to about 1 mm (optionally a thickness of about 0.3 mm, optionally a thickness of about 0.5 mm, optionally a thickness of about 0.7 mm, optionally a thickness of about 1.0 mm).

Aspect 36: The method of any one of the preceding Aspects, wherein the down-draw process being a slow draw or fusion draw process.

Aspect 37: The method of any one of the preceding Aspects comprising forming a sheet of the glass material.

### EXAMPLES

The disclosure can be further understood by the following non-limiting examples.

### Examples 1-23

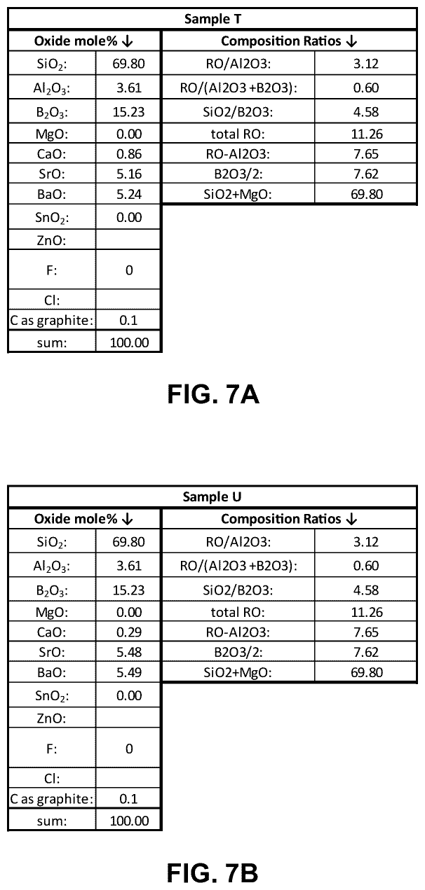

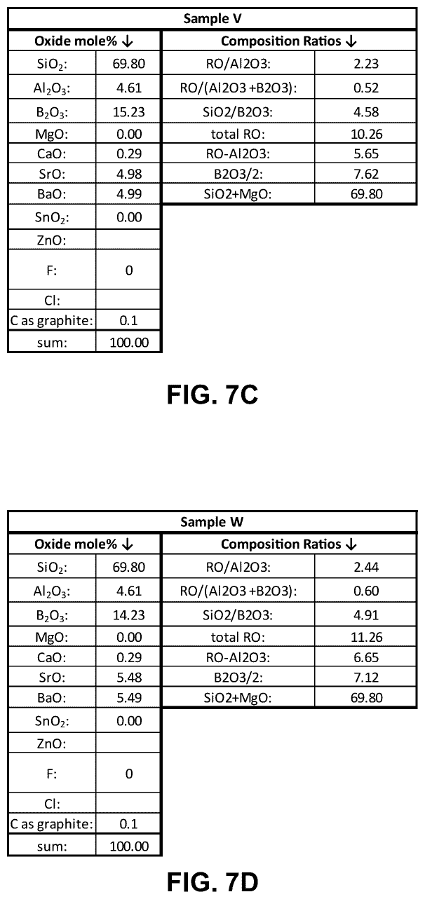

Each of Examples 1-23 corresponds to each of Samples A through W, respectively, each sample being an independent example of glass materials disclosed herein. Each of FIGS. 5A-5F, 6A-6M, and 7A-7D independently summarizes the batch materials used to make the identified respective sample, the composition in mol. % on an oxide basis, and compositional ratios, such as RO/Al₂O₃. Where available, additional characteristics are provided for various samples, such as optical characteristics such as transmission at 248 nm for one or more thicknesses of a sheet of the respective example glass material, physical characteristics such as density of the respective example glass material, high temperature viscosity (HTV) related characteristics of the respective example glass material, and/or additional characteristics such as liquidus viscosity of the respective example glass material. In the case of samples for which carbon is used during manufacture, the amount of carbon is provided as a mol. % with respect the other identified species. However, the carbon is added with or on top of the glass compositions as a reducing agent and it generally burns off during melting of the glass, so the carbon is generally not incorporated into the final glass composition. Therefore, where carbon is used, the “sum” row shows 100% of batched materials plus the respective mol. % of carbon (e.g., 100%+0.10%, or 100.10%).

The tables in FIGS. 5A-5F include HTV characteristics, where the parameters A, B, and T₀ are fitting constants, which are generally material-dependent, corresponding to the Vogel-Fulcher-Tammann (VFT) equation. The equation for determining temperature at a reference liquidus viscosity is [T_{liq}=T₀+B/(log (μ_{liq})−A)], where “μ_{liq}” is liquidus viscosity in units of poise, T_{liq} is the liquidus temperature (° C.), and A, B, and T₀ are the fitting constants identified in FIGS. 5A-5F. In the tables of FIGS. 5A-5F, the A, B, and T₀ parameters are followed by temperatures at different viscosities (0.25 kP, 0.30 kP, 0.70 kP, 2.0 kP, 35 kP, and 200 kP) as determined by Fulcher fit to high temperature viscosity (HTV) data. Similarly, these constants may be used to determine liquidus viscosity at a reference liquidus temperature using the equation [μ_{liq}=A+B/(T_{liq}−T₀)].

In FIGS. 5A-5F, the “primary phase” characteristics is an identification of the primary crystal phase that will or would come out in the respective glass material when the glass temperature is in equilibrium with the crystal. In other words, if one were to hold the respective glass material at that equilibrium temperature or let it sit for any amount of time at that equilibrium temperature, the crystal phase corresponding to the identified “primary phase” would crystallize. However, generally these glass materials are cooled quickly enough such that they are frozen-in before they experience the temperature that would generate crystals and thus these glass material samples are generally substantially amorphous, having very low crystallinity or being substantially free of crystalline phases.

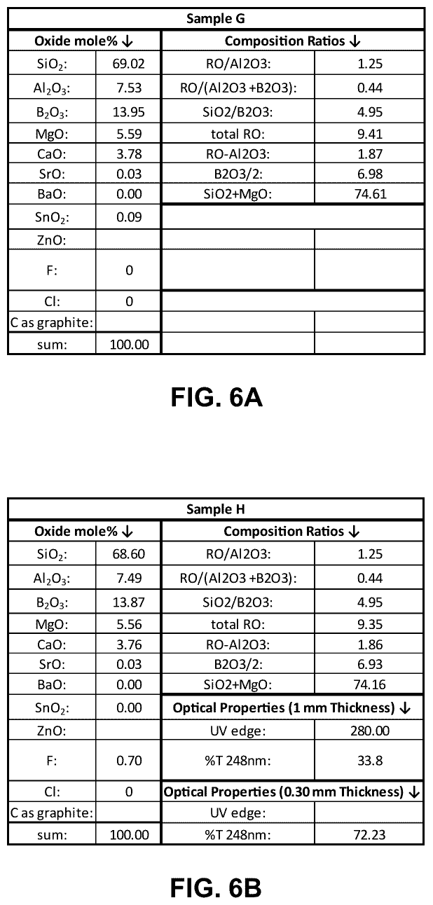

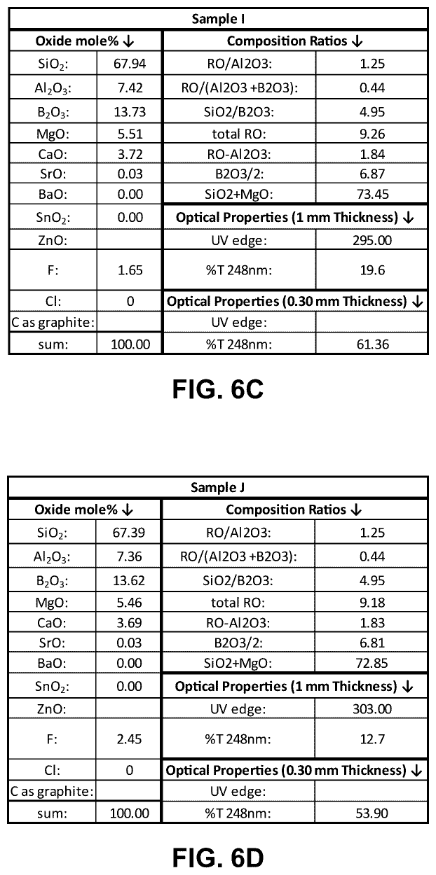

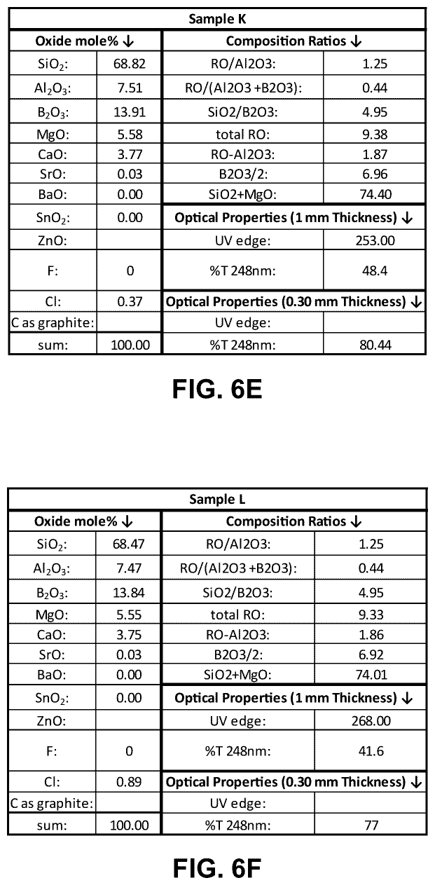

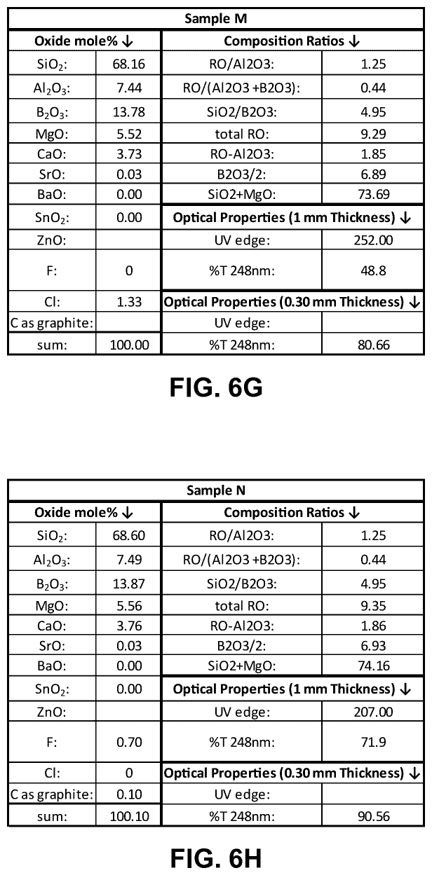

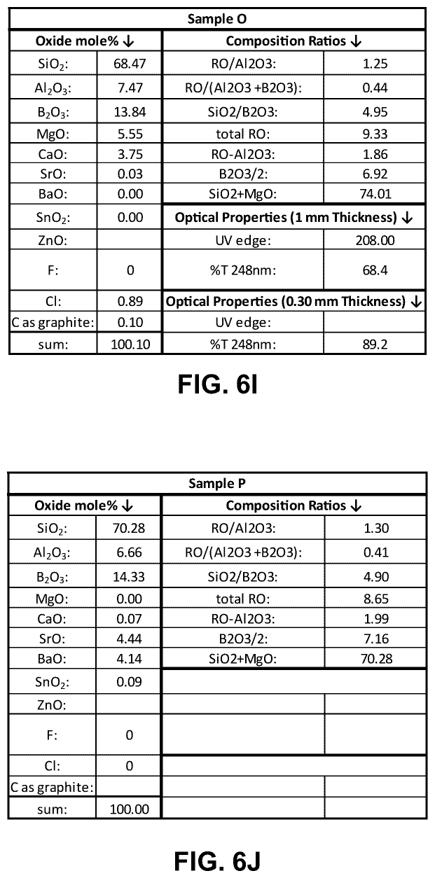

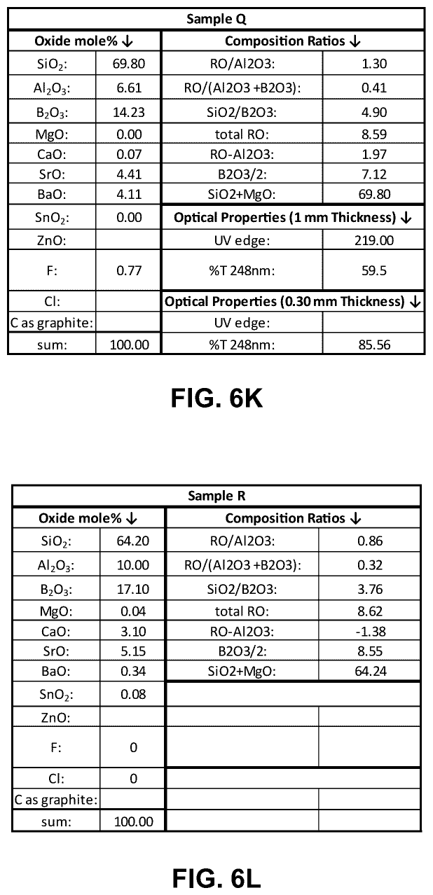

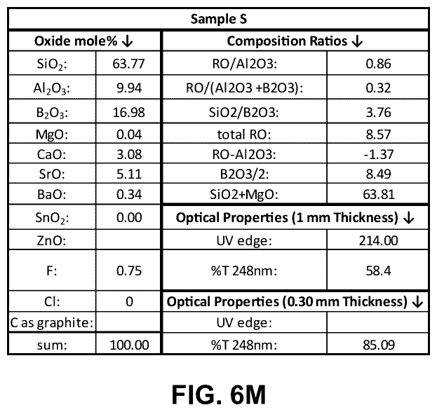

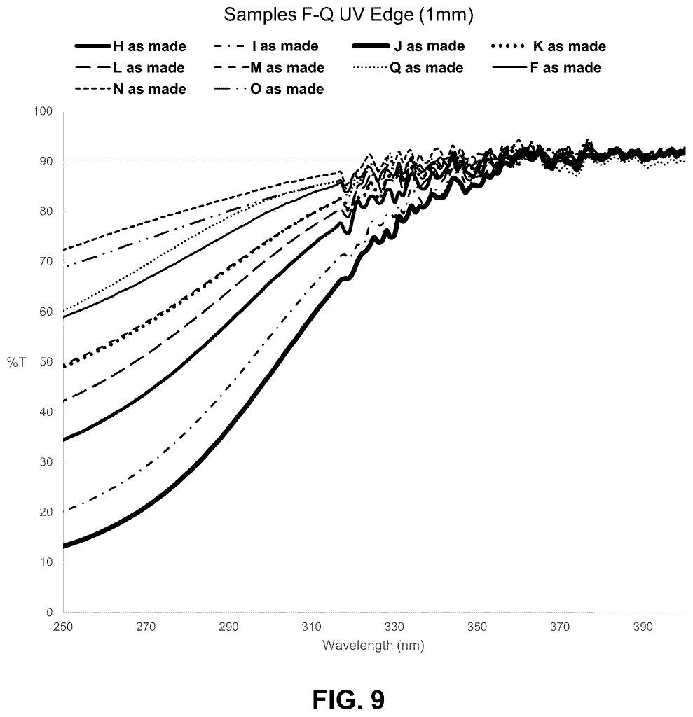

FIGS. 3, 9, 10, and 11A-11B show optical transmission (% T) data for a selection of the compositions from among samples A through W, for which compositional details are provided in FIGS. 5A-5F and 6A-6M, with thickness of the glass materials identified in the plot. FIG. 3 shows % T data for 0.3 mm thick glass sheets of glass material corresponding to samples A through F. FIGS. 9, 10, 11A, and 11B show % T data for 1 mm thick glass sheets of glass materials corresponding to select samples from among samples F-Q.

The samples G through S summarized in FIGS. 6A-6M are based on low loss glass (LLG) fusion formable compositions. For Samples H, I, and J, compositions were melted with three levels of F to determine amount needed for fining and solarization prevention. For Samples K, L, and M, compositions were melted with 3 levels of Cl⁻ to determine if Cl⁻ can act as a finer and/or solarization prevention, as Cl⁻ may provide beneficial compatibility with manufacturing processes. Melted glass are analyzed looking at (Sr+Ba) as compared to (Mg+Ca)(e.g., Q vs. H). Melted glass are analyzed looking at (Ca+Sr+Ba) as compared to (Mg+Ca) and (Sr+Ba) (e.g., S vs. H vs. Q). Melted samples H and L are formed without carbon.

FIG. 9 provides experimental results showing UV transmission (% T) as a function of wavelength (nm) for example LLG glasses formed with low Fe raw materials as well as Cl⁻, F⁻ and carbon. Compositions N and O exhibit the highest UV transmission at 250 nm and are the two glasses with carbon added to keep the melt reduced. The glasses containing (Sr+Ba) or (Sr+Ca) exhibit higher UV transmission as compared to those with (Mg+Ca), which may relate to Fe tramp content in batch/source material even though the examples used high purity or low Fe raw materials. The transmission is also observed to increase with decreasing F⁻ and Cl⁻ in the glass. Cl⁻ containing glasses are observed to generally exhibit better UV transmission than F-containing glasses.

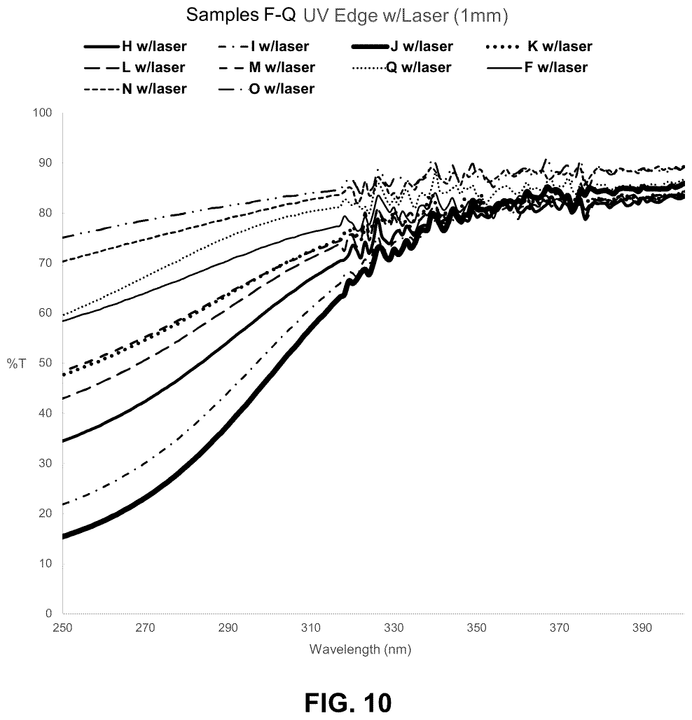

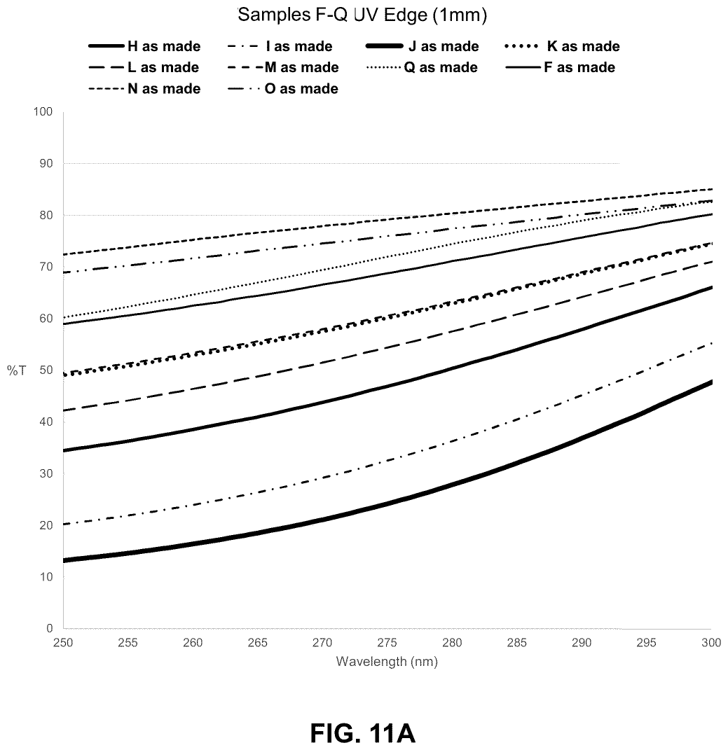

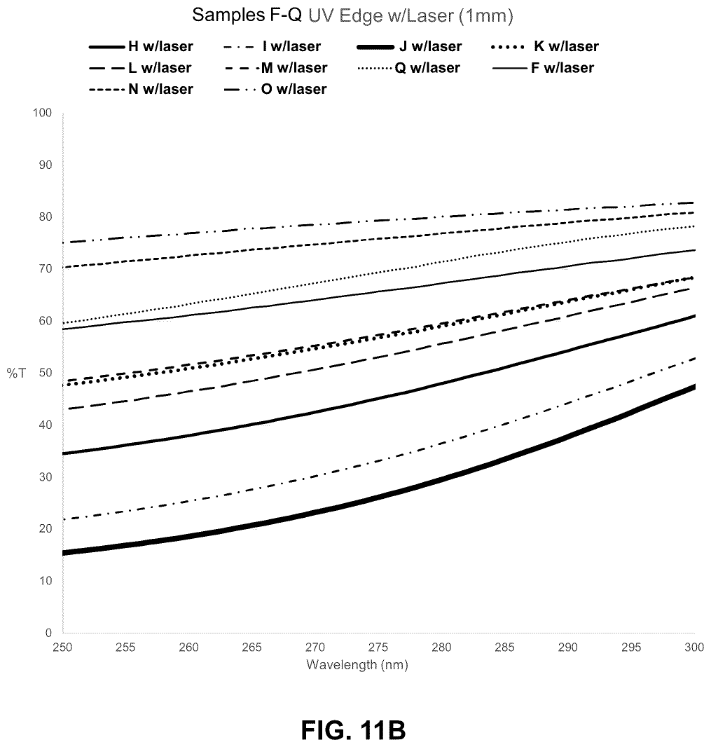

FIGS. 8-11B provide example results evaluating UV transmission characteristics upon exposure to UV laser light. The laser set up for UV exposure employed: pulses ˜4 min duration at a frequency of 10 Hz for a total of approx. 2400 pulses and a fluence of approx. 110 mJ/pulse. This experimental procedure simulates an over saturation to act as a go/no-go method. Generally, if the glass solarizes, it solarizes quickly and if it does not solarize quickly it will eventually densify similar to fused silica after a significant number of laser shots. As a reference, for example, FIG. 8 shows absorption at 250 nm for an example glass material vs. number of laser shots of a UV laser, wherein a rapid increase in absorption is observed. The glass composition used to obtain in the data in FIG. 8 is as follows: 76.38 mol. % SiO₂, 5.18 mol. % Al₂O₃, 11.66 mol. % N₂O, 6.61 mol. % MgO, 0.03 mol. % CaO, 0.1 mol. % SnO₂, and 0.05 mol. % Fe₂O₃. In contrast, FIGS. 9 and 10 provide the UV transmission curves for example UV transmissive glass compositions before and after UV laser exposure, respectively. As shown in FIG. 10, there does not appear to be an observed effect of laser exposure on the UV transmission of these glasses, for example, such that there appears to be no solarization effects observed. FIGS. 11A and 11B provide blown up images of UV transmission results before and after UV laser exposure.

### Example 24: Exemplary Methods of Making Glass Materials

Glass materials disclosed herein may be formed according to any methods disclosed herein, such as down-draw methods discussed above, such as fusion draw methods.

In further aspects, glass materials, such as any of samples 1-23 are optionally made in a crucible melt. For example, the batch materials are melted in a quartz lined crucible at temperature sufficient to melt the materials and form the glass, such as 1650° C., for a time sufficient to allow full melting and mixing of the materials, such as six hours, with a Si lid on the crucible. After melting, the molten glass material is poured on a surface and then annealed at an annealing point just after red color leaves the glass, for example.

### STATEMENTS REGARDING INCORPORATION BY REFERENCE AND VARIATIONS

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred aspects, exemplary aspects and optional features, modification and variation of the concepts herein disclosed may be resorted to by those skilled in the art, and that such modifications and variations are considered to be within the scope of this invention as defined by the appended claims. The specific aspects provided herein are examples of useful aspects of the present invention and it will be apparent to one skilled in the art that the present invention may be carried out using a large number of variations of the compositions, materials, material components, devices, device components, and methods steps set forth in the present description. As will be obvious to one of skill in the art, methods and devices useful for the present methods can include a large number of optional composition and processing elements and steps.

As used herein and in the appended claims, the singular forms “a”, “an”, and “the” include plural reference unless the context clearly dictates otherwise. Thus, for example, reference to “a cell” includes a plurality of such cells and equivalents thereof known to those skilled in the art. As well, the terms “a” (or “an”), “one or more” and “at least one” can be used interchangeably herein. It is also to be noted that the terms “comprising”, “including”, and “having” can be used interchangeably. The expression “of any of claims XX-YY” (wherein XX and YY refer to claim numbers) is intended to provide a multiple dependent claim in the alternative form, and in some aspects is interchangeable with the expression “as in any one of claims XX-YY.”

When a group of substituents is disclosed herein, it is understood that all individual members of that group and all subgroups, are disclosed separately. When a Markush group or other grouping is used herein, all individual members of the group and all combinations and subcombinations possible of the group are intended to be individually included in the disclosure. When a compound is described herein such that a particular isomer, enantiomer or diastereomer of the compound is not specified, for example, in a formula or in a chemical name, that description is intended to include each isomers and enantiomer of the compound described individual or in any combination. Additionally, unless otherwise specified, all isotopic variants of compounds disclosed herein are intended to be encompassed by the disclosure. For example, it will be understood that any one or more hydrogens in a molecule disclosed can be replaced with deuterium or tritium. Isotopic variants of a molecule are generally useful as standards in assays for the molecule and in chemical and biological research related to the molecule or its use. Methods for making such isotopic variants are known in the art. Specific names of compounds are intended to be exemplary, as it is known that one of ordinary skill in the art can name the same compounds differently.

With regard to any salts disclosed herein, one of ordinary skill in the art can select from among a wide variety of available counterions those that are appropriate for preparation of salts of this disclosure for a given application. In specific applications, the selection of a given anion or cation for preparation of a salt may result in increased or decreased solubility of that salt.

Every material, composition, component, article, and method described or exemplified herein can be used to practice the disclosure, unless otherwise stated.

Whenever a range is given in the specification, for example, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the disclosure pertains. References cited herein are incorporated by reference herein in their entirety to indicate the state of the art as of their publication or filing date and it is intended that this information can be employed herein, if needed, to exclude specific aspects, embodiments, components, compositions, etc. that are in the prior art.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms. The disclosure illustratively described herein suitably may be practiced in the absence of any element or elements, limitation or limitations which is not specifically disclosed herein.

One of ordinary skill in the art will appreciate that starting materials, synthetic methods, purification methods, and analytical methods, other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred aspects and optional features, modification and variation of the concepts herein disclosed may be resorted to by those skilled in the art, and that such modifications and variations are considered to be within the scope of this invention as defined by the appended claims.

What is claimed is:

1. A glass material comprising:
a composition comprising, on an oxide basis:
silica selected from the range of 55 mol. % to 75 mol. %;
alumina selected from the range of 1 mol. % to 20 mol. %; and
boric oxide selected from the range of 10 mol. % to 20 mol. %;
wherein the composition comprises an RO/Al₂O₃ ratio, on an oxide basis, selected from the range of 0.80 to 3.5, the term RO being the mol. % sum of MgO, CaO, SrO, and BaO;
wherein the glass material comprises a total content by weight of amorphous phase being greater than a total content by weight of crystalline phase; and
wherein the glass material is characterized by a light transmission of at least 50% at a wavelength selected from the range of 245 nm to 270 nm when the glass material is in the form of a sheet having a thickness selected from the range of 0.3 mm to 1 mm.

2. The glass material of claim 1 comprising a total crystallinity of less than 5 wt. %.

3. The glass material of claim 1, wherein the glass material is characterized by a light transmission of at least 50% of light having a wavelength of 248 nm, 254 nm, and/or 266 nm when the glass material is in the form of a sheet having a 1 mm thickness.

4. The glass material of claim 1, wherein the composition is substantially free of F or comprises less than 0.7 mol. % of F.

5. The glass material of claim 1, wherein the composition is substantially free of alkali metals or wherein the composition comprises a sum of Li₂O, Na₂O, K₂O, Rb₂O and Cs₂O being less than 0.1 mol. %.

6. The glass material of claim 1, wherein the composition comprises less than 0.01 wt. % of Fe(III).

7. The glass material of claim 1, wherein the composition comprises a sum of SnO₂, ZnO, F, Cl, and C being less than 0.5 mol. %.

8. The glass material of claim 1, wherein the composition is substantially free of a cordierite crystal phase.

9. The glass material of claim 1, wherein the composition comprises an RO/(Al₂O₃+B₂O₃) ratio, on an oxide basis, selected from the range of 0.3 to 0.65.

10. The glass material of claim 1, wherein the composition comprises a mol. % ratio of SiO₂/B₂O₃ selected from the range of 3.2 to 5.0.

11. The glass material of claim 1, wherein the composition comprises RO selected from the range of 8.5 to 11.5 mol. %.

12. The glass material of claim 1, wherein the composition comprises |RO−Al₂O₃| being selected from the range of 1.0 to 8.0 mol. %.

13. The glass material of claim 1, wherein the composition comprises (B₂O₃)/2 being selected from the range of 6.9 to 8.5.

14. The glass material of claim 1, wherein the composition comprises a sum of SiO₂ and MgO being selected from the range of 63 to 75 mol. %.

15. The glass material of claim 1, wherein the composition comprises, on an oxide basis:
SiO₂ selected from the range of 60 mol. % to 72 mol. %;
Al₂O₃ selected from the range of 6 mol. % to 11 mol. %; and
B₂O₃ selected from the range of 11 mol. % to 18 mol. %.

16. The glass material of claim 1, wherein the composition comprises the RO/Al₂O₃ ratio, on an oxide basis, being selected from the range of 0.80 to 1.35.

17. The glass material of claim 1, wherein the glass material is characterized by a Young's modulus selected from the range of 60 to 70 GPa.

18. The glass material of claim 1, wherein the glass material is characterized by a liquidus viscosity greater than or equal to 120 kilopoise (kP).

19. The glass material of claim 1, wherein the glass material is characterized by a liquidus internal temperature selected from the range of 900 to 1100° C.

20. A method of making a glass material, the method comprising:
providing a precursor composition comprising silica, alumina, boric acid, and at least one of magnesium oxide, calcium oxide, strontium oxide, and barium oxide; and
forming the glass material from a precursor composition using a down-draw process;
wherein the glass material comprises:
a composition comprising, on an oxide basis:
silica selected from the range of 55 mol. % to 75 mol. %;
alumina selected from the range of 1 mol. % to 20 mol. %; and
boric oxide selected from the range of 10 mol. % to 20 mol. %;
wherein the composition comprises an RO/Al₂O₃ ratio, on an oxide basis, selected from the range of 0.80 to 3.5, the term RO being the mol. % sum of MgO, CaO, SrO, and BaO;
wherein the glass material comprises a total content by weight of amorphous phase being greater than a total content by weight of crystalline phase; and
wherein the glass material is characterized by a light transmission of at least 50% at a wavelength selected from the range of 245 nm to 270 nm when the glass material is in the form of a sheet having a thickness selected from the range of 0.3 mm to 1 mm.
